(19) United States
(12) Patent Application Publication
(10) Pub. No.: US 2008/0065996 A1
(43) Pub. Date: Mar. 13, 2008

(54) Desktop sharing method and system

(75) Inventors: Vicki Elizabeth Noel, Calgary (CA); Derek Ronald Gour, Calgary (CA); Benjamin Lovece, Calgary (CA); Daniel James Mitchell, Calgary (CA); Taco van Ieperen, Calgary (CA); Patrick Wai Keung Lee, Calgary (CA); Yiping Zhou, Calgary (CA)

Correspondence Address: BEYER WEAVER LLP, P.O. BOX 70250, OAKLAND, CA, 94612-0250, US

(73) Assignee: SMART Technologies Inc.

(21) Appl. No.: 11/712,618

(22) Filed: Mar. 1, 2007

Related U.S. Application Data
(63) Continuation of application No. 11/484,153, filed on Jul. 10, 2006, now abandoned.
Application No. 11/484,153 is a continuation of application No. 11/292,940, filed on Dec. 1, 2005, now abandoned.
Application No. 11/292,940 is a continuation of application No. 10/888,793, filed on Jul. 9, 2004.
(60) Provisional application No. 60/577,606, filed on Jun. 8, 2004.

(30) Foreign Application Priority Data
Nov. 18, 2003 (DE) 10353785.6-41

(51) Int. Cl. G06F 3/00; G06F 12/00; G06F 15/00; G06F 15/16; G06F 17/30

(52) U.S. Cl. 715/753; 707/1; 707/203; 709/219; 715/201; 715/733; 707/E17.001

(57) ABSTRACT

A desktop sharing system and method are provided. A desktop sharing application permits a selected display region on a first computer's desktop to be shared with other computers. The desktop sharing application permits another computer to assume control and share a selected display region of the other computer's desktop during a conference.

### CROSS-REFERENCE TO RELATED APPLICATION

This application is a continuation application of U.S. patent application Ser. No. 11/484,153filed Jul. 10, 2006 and entitled “DESKTOP SHARING METHOD AND SYSTEM”, which is hereby incorporated herein by reference, which is a continuation application of U.S. patent Ser. No. 11/292,940, filed Dec. 1, 2005, and entitled “DESKTOP SHARING METHOD AND SYSTEM,” which is hereby incorporated herein by reference, which is a continuation application of U.S. patent application Ser. No. 10/888,793, filed Jul. 9, 2004, and entitled “DESKTOP SHARING METHOD AND SYSTEM,” which is hereby incorporated herein by reference, and which claims the benefit of U.S. patent application Ser. No. 60/577,606, filed on Jun. 8, 2004.

### FIELD OF THE INVENTION

The present invention relates generally to data sharing among different computers and in particular to a method and system for controlling graphical information from a host computer that is displayed on at least one remote client computer. The present invention also relates to a method and system for managing data transfer between computers sharing graphical information and to a method and system of providing feedback to a presenter relating to viewers of a presentation.

### BACKGROUND OF THE INVENTION

Networked computer systems including computers executing desktop sharing applications to permit the computers to share displayed information are widely known and used. In these computer systems, one computer (the host computer) transmits images of its desktop to a plurality of remote computers using such a desktop sharing application. The remote computers may use a variety of strategies to display the host computer desktop images depending on the operating environments of the remote computers.

Windows is a well-known operating environment for computers. In this operating environment, information to be presented to a user is displayed by a desktop graphical user interface in one or more windows. Some of these windows and the desktop graphical user interface itself can contain sensitive information that is not desired to be shared with other users. Further, some portions of the desktop graphical user interface and windows provide access to functionality that is not to be shared. Presently, desktop sharing applications typically share the entire desktop, providing remote users with access to the entire content of the host's desktop and, in some instances, its entire functionality.

In computer systems that share displayed information and operate in the Windows environment, when images of the host computer desktop are transmitted to the remote computers via a conferencing server, each remote computer displays the host computer desktop image within a window. Unfortunately, displaying the host desktop image in this manner can be problematic. Such desktop sharing requires a large, stable network connection between each of the personal computers and the conferencing server, especially where other applications, such as video conferencing, are run at the same time. Where one or more remote computers suffer inadequate network connection stability and bandwidth, the remote computers can lag behind in receiving and displaying graphical information from the host computer. Current desktop sharing applications provide no indication to the presenter of such a situation.

Desktop sharing applications are also typically run in corporate computing environments that often direct all communication, both inbound and outbound, through a firewall of some kind. Depending on the policy established for the firewall, the firewall may inhibit desktop sharing applications from communicating with remote computers located on the other side of the firewall.

As will be appreciated, improvements in graphical user interfaces in environments where computers share displayed information are desired. It is therefore an object of the present invention to provide a novel method and system for sharing displayed images from a host computer on at least one remote computer in such a manner that control over what is shared is provided to the host. It is also an object of the present invention to provide a novel desktop sharing application that is aware of the state of the desktop sharing on remote computers. Further, it is an object of the present invention to provide a novel desktop sharing application that is able to communicate through firewalls.

### SUMMARY OF THE INVENTION

In one aspect of the invention, there is provided, in a distributed computer network where displayed information is shared between at least two computers, a method of displaying shared images comprising the steps of: identifying image data within a selected display region of one computer that is to be shared with at least one other computer; and displaying the identified image data at said at least one other computer.

In another aspect of the present invention, there is provided, In a distributed computer network where displayed information is shared between at least two computers, a method of displaying shared images comprising the steps of: dividing image data of one computer that is to be shared with at least one other computer into a plurality of tiles; examining the image data in the tiles to determine the nature thereof; compressing the image data in the tiles using a compression methodology selected based on the determined nature; and transmitting the compressed image data to said at least one other computer for display.

In a further aspect of the present invention, there is provided a distributed computer network where displayed information is shared between at least two computers, a method of displaying shared images comprising the steps of: identifying image data of one computer that is to be shared with at least one other computer during a presentation; transmitting the identified image data to said at least one other computer for display; and providing feedback at at least one of said one and other computers concerning the position of the at least one other computer within the presentation.

In a still further aspect of the present invention, there is provided, in a distributed computer network where displayed information is shared between at least two computers, a method of displaying shared images comprising the steps of: identifying image data of one computer that is to be shared with at least one other computer during a presentation; transmitting the identified image data to said at least one other computer for display; detecting other computers that fall behind in the presentation; and forcing other computers that fell behind in the presentation to catch up.

In yet another aspect of the present invention, there is provided, in a distributed computer network, a method of inviting a user to participate in an interactive session, comprising: sending a message with a URL to the user, said URL identifying the address of a conferencing application enabling participation in the interactive session; receiving a request from the user for the conferencing application; associating the request with the session; and transmitting the conferencing application and data identifying the session to the user.

In yet another aspect of the present invention, there is provided a method of providing version control in an application, comprising: executing an original version of the application, the original version residing in a permanent location; retrieving a desired version of an application and storing the desired version in a temporary location; executing the desired version in the temporary location; terminating the execution of the original version of the application; copying the desired version over the original version at the permanent location with the executing desired version; executing the desired version at the permanent location; and terminating execution of the desired version at the temporary location.

In yet another aspect of the present invention, there is provided a method of installing components dynamically on a computer, comprising: determining with an application that a component containing functionality required by the application is not available on the computer; retrieving the component containing the required functionality with the application; and accessing the required functionality with the application.

In yet another aspect of the present invention, there is provided, in a conferencing system operating over a distributed computer network, a method of transmitting streaming video to a client from a plurality of streaming video sources, the client presenting a plurality of frames, each of the plurality of frames displaying streaming video from a separate streaming video source, the method comprising: determining if a frame associated with streaming video has been hidden; and terminating the transmission of streaming video associated with said hidden frame.

In yet another aspect of the present invention, there is provided, in a conferencing system operating over a distributed computer network, a method of transmitting streaming video to a client from a plurality of streaming video sources, the client presenting a plurality of frames, each of the plurality of frames displaying streaming video from a separate streaming video source, the method comprising: transmitting streaming video to the client from each separate streaming video source at a frame rate at least partially dependent on the size of the frame in which each separate streaming video source is displayed.

In yet another aspect of the present invention, there is provided, in a conferencing application, a method of displaying streaming video from a plurality of streaming video sources, the method comprising: presenting each of said plurality of streaming video sources in a plurality of frames, one of said frames being larger than the other of said frames; detecting when a smaller frame has been selected; and switching the position and size of said one frame and said selected smaller frame.

In yet another aspect of the present invention, there is provided, in a distributed computer network where displayed information is shared between at least two computers, a method of displaying shared images comprising the steps of: enabling a first participant to generate annotations on a shared region of a desktop of one computer; and displaying the annotations on the shared region of the desktop on a second computer.

In yet another aspect of the present invention, there is provided, in a distributed computer network where displayed information is shared between at least two computers, a method of displaying a shared desktop comprising the steps of: sharing a region of a first computer's desktop with a second computer; and modifying the display of said region at said second computer to identify displayed controls unavailable to the second computer.

In yet another aspect of the present invention, there is provided, in a distributed computer network where displayed information is shared between at least two computers, a method of displaying a shared desktop comprising the steps of: sharing a region of a first computer's desktop with a second computer; and modifying the display of said region at said second computer to identify displayed applications unavailable to the second computer.

In yet another aspect of the present invention, there is provided a desktop sharing application, comprising: a shared display region; said desktop sharing application being dynamically conditionable between a host mode, wherein said shared display region displays a shared region of the desktop of a computer upon which the desktop sharing application is executing, and a client mode, wherein said shared display region displays a shared region of the desktop of another computer executing the desktop sharing application conditioned in host mode with which said desktop sharing application is in communication.

In still yet another aspect of the present invention, there is provided, in a distributed computer network where displayed information is shared between at least two computers, a method of displaying a shared desktop comprising the steps of: sharing a region of a desktop on a first computer with a second computer; receiving by the first computer a request from the second computer to share a region of the second computer's desktop; and sharing the region of the second computer's desktop with the first computer.

### BRIEF DESCRIPTION OF THE DRAWINGS

Embodiments of the present invention will now be described, by way of example only, with reference to the attached drawings in which:

FIG. 1 shows a schematic representation of a typical network topology in which the present invention is employed;

FIG. 2 shows a presenter's graphical user interface (“GUI”) of a desktop sharing application in accordance with the present invention;

FIG. 3 shows a viewer's GUI corresponding to the presenter's GUI of FIG. 2;

FIG. 4 shows the viewer's GUI, wherein the presenter has revealed a conference participant list;

FIG. 5 shows the viewer's GUI, wherein the presenter has invited another participant to the conference via selection of an invite button shown in FIG. 4;

FIG. 6 shows the viewer's GUI wherein web camera (“webcam”) video is being displayed in a frame and a sub-frame;

FIG. 7 shows the presenter's GUI includes the webcam video and a webcam menu;

FIG. 8 shows the presenter's GUI with the Tools sub-menu of the main menu revealed;

FIG. 9 shows the viewer's GUI corresponding to the presenter's GUI of FIG. 8;

FIG. 10 shows the presenter's GUI wherein two participants are drawing;

FIG. 11 shows the viewer's GUI corresponding to the presenter's GUI of FIG. 10;

FIG. 12 shows the presenter's GUI after resizing;

FIG. 13 shows the viewer's GUI corresponding to the resized presenter's GUI of FIG. 12;

FIG. 14 shows the viewer's GUI, wherein the viewer is waiting to share his desktop;

FIG. 15 shows the presenter's GUI of FIG. 2 wherein a dialog box appears to grant permission to the viewer to share his desktop;

FIG. 16 shows the new presenter's GUI while waiting for desktop sharing to commence;

FIG. 17 shows the new presenter's GUI after desktop sharing is assumed;

FIG. 18 shows the old presenter's GUI after desktop sharing is assumed;

FIG. 19 is a flowchart illustrating the general method of compressing, sending and reconstructing frames performed during desktop sharing in accordance with the present invention;

FIG. 20 is a flowchart showing the method of identifying tiles for jpeg compression forming part of the general method of FIG. 19;

FIG. 21 is a flowchart showing the method of preparing a keyframe forming part of the general method of FIG. 19;

FIG. 22 is a flowchart showing the method of generating and sending a keyframe or delta forming part of the general method of FIG. 19;

FIG. 23 is a flowchart showing the method of compressing and sending tiles identified for jpeg compression forming part of the general method of FIG. 19;

FIG. 24 is a flowchart showing the method of reconstructing a frame of image data forming part of the general method of FIG. 19;

FIG. 25 shows an image presented in the shared region of the presenter's GUI to be transmitted to viewers;

FIG. 26 shows the shared region of FIG. 25 divided into tiles;

FIG. 27 shows a set of tiles from the shared region that are selected for JPEG compression;

FIG. 28 shows the shared region of FIG. 25, wherein the tiles selected for JPEG compression are blacked out;

FIG. 29 shows another image presented in the shared region of the presenter's GUI to be transmitted to viewers;

FIG. 30 shows the shared region of FIG. 29 divided into tiles;

FIG. 31 shows the shared region, wherein the tiles selected for JPEG compression are blacked out;

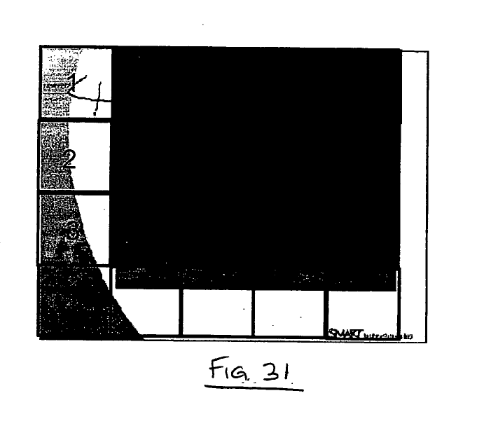

FIG. 32 shows yet another image presented in the shared region of the presenter's GUI to be transmitted to viewers;

FIG. 33 shows the shared region of FIG. 32, wherein tiles for which Camtasia delta data is unavailable are grayed out;

FIG. 34 shows the shared region of FIG. 32, wherein a Camtasia keyframe is generated;

FIG. 35 shows the presenter's GUI wherein the participants menu button is altered to indicate lag;.

FIG. 36 shows a conferencing server and conference selection dialog box;

FIG. 37 shows a dialog box for joining a conference;

FIG. 38 shows a dialog box for creating a conference; and

FIG. 39 shows the presenter's GUI while waiting for other conference participants to arrive.

### DETAILED DESCRIPTION OF THE INVENTION

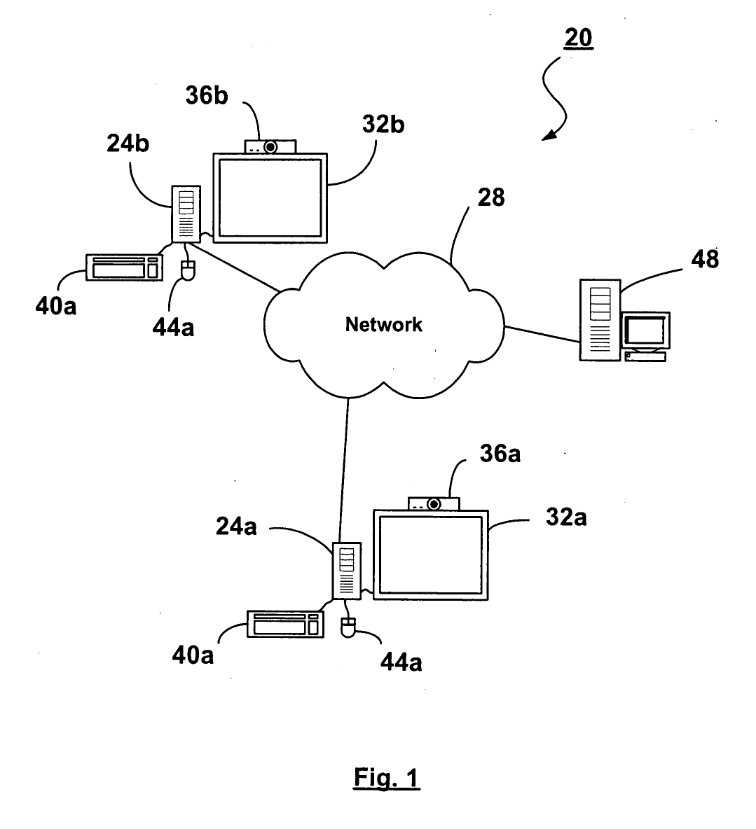

Turning to FIG. 1, an exemplary computing environment 20 is shown and includes a pair of computers 24a, 24b communicating over a communication network 28. The computers 24a, 24b communicate with touch screens 32a, 32b of the type described in U.S. patent application Ser. No. 10/312,983 to Morrison et al. and U.S. patent application Ser. No. 10/354,168 to Akitt et al., the contents of which are incorporated herein by reference. The computers 24a, 24b also communicate with web cameras 36a, 36b (referred to hereinafter as “webcams”), keyboards 40a, 40b and mice 44a, 44b. Each of the computers 24a, 24b is also in communication with a conferencing server 48 via the communication network 28. Those of skill in the art will appreciate that two computers are shown for ease of illustration. In a typical conferencing environment, many computers will communicate over the communication network 28.

Each of the personal computers 24a and 24b operates in a Windows environment and includes a desktop. As used herein, “desktop” means the graphical user interface of an operating system and applications displayed on a monitor. This includes, but is not limited to, the “desktop” of an operating system, controls such as taskbars and scroll bars, any icons and application windows.

The desktop allows information to be presented to a user in windows. Each personal computer runs a desktop sharing application that permits the personal computers 24a and 24b to share displayed information. In this particular example, the personal computers 24a and 24b run SMART Bridgit Conferencing Software. This desktop sharing application allows a conference to be set up between personal computers with one personal computer being designated as a host computer and the remaining personal computers being designated as client computers. Images of the host computer desktop are transmitted to the client computers in the conference via the conferencing server 48 and are displayed on the monitors of the client computers full screen. In the environment of FIG. 1, the host computer desktop is presented on the touch screens 32a and 32b. The client computers can be permitted to control the host computer to a degree.

Both the host and client computers are in communication with the conferencing server 48 via SSL connections to provide security for any sensitive information being transmitted.

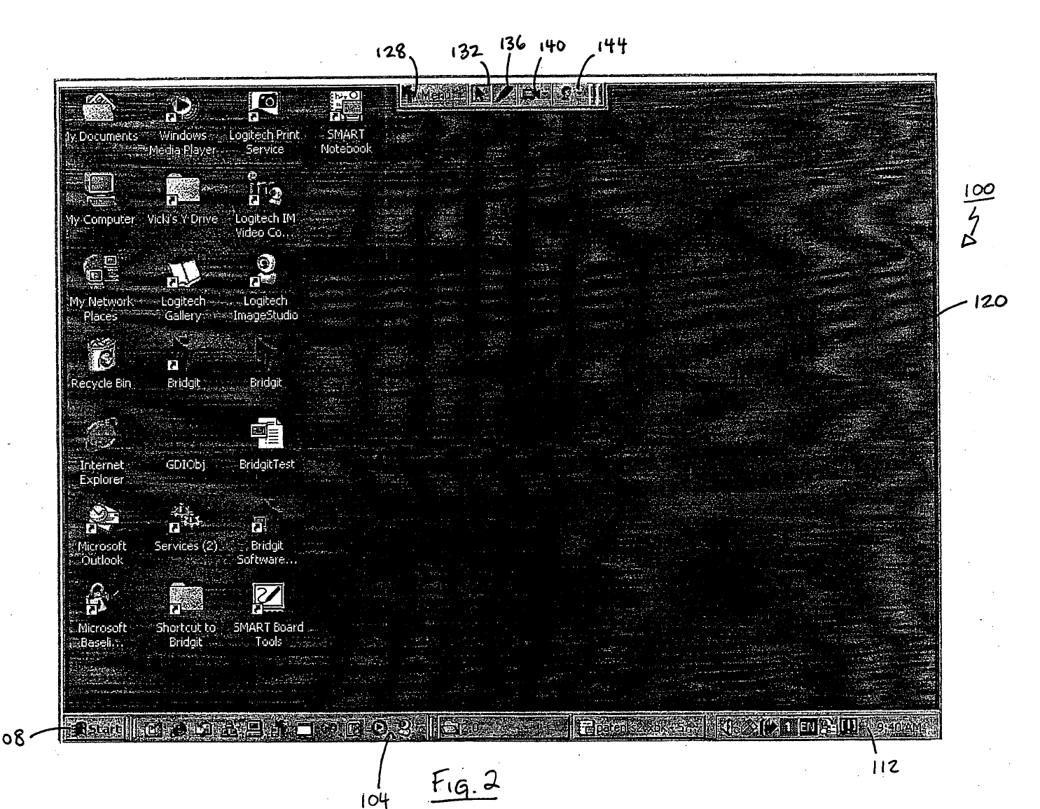

FIG. 2 shows the graphical user interface (“GUI”) 100 of the desktop sharing application running on the host computer. The GUI 100 comprises a window on the desktop of the operating system. The desktop of the operating system includes a taskbar 104 providing access to a set of functionality through a program menu button 108 and a notification area 112. The GUI 100 is shown having a shared region 116 defined by a frame 120. A toolbar 124 is shown anchored to the top of the frame and includes a set of buttons, including a main menu button 128, a pointer option button 132, a drawing option button 136, a webcam menu button 140 and a participants list button 144.

The frame 120 of the GUI 100 can be adjusted as desired to select the initial shared region 116 of the desktop for the conference. In this manner, the host or presenter can control the portions of the host computer's desktop that are transmitted to client computers and presented to viewers. It can be desirable in some circumstances to manipulate the frame 120 to exclude sensitive controls from the shared region, thereby ensuring that other participants are not granted access to them. Only one of the pointer option button 132 and the drawing option button 136 can be selected at one time. In this example, the pointer option button 132 is selected, indicating that pointer input will be interpreted as mouse pointer events. When the drawing option button 136 is selected, pointer input is interpreted as drawing events. The participants list button 144 can be toggled to display or hide a list of participants in the conference. In this list, the presenter is identified with the word “presenter” appearing below his name.

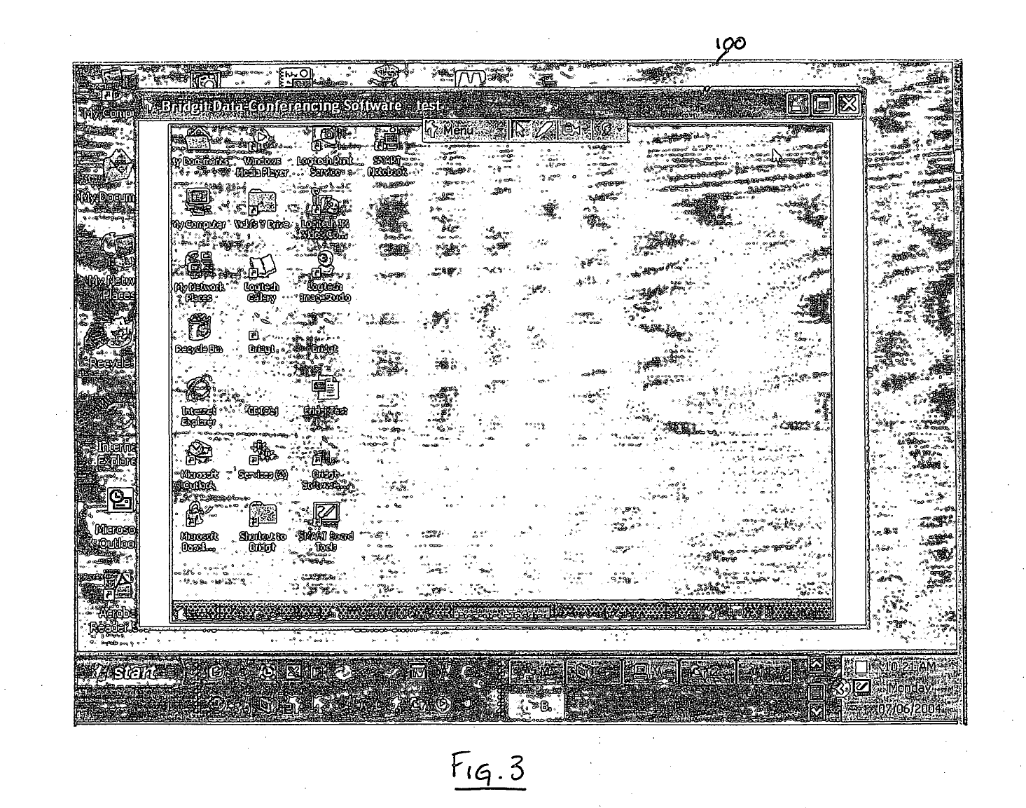

FIG. 3 shows the GUI 100 as it appears to a non-presenting participant or viewer. The GUI 100 takes the form of a window overlying the client computer's desktop. The GUI 100 shows the shared region 116 of the presenter's desktop, and has the same toolbar 124 shown. In this example, the presenter has elected not to allow viewers to control remotely the presenter's desktop. As a result, certain areas of the shared region 116, such as the taskbar 104, are hatched to indicate to the viewer that the taskbar is that of the presenter and not that on his desktop, and that interaction with the taskbar is not possible.

The presenter can optionally select to hatch or entirely hide windows associated with particular programs. For example, where an instant messaging client is installed on the presenter's computer, it can be desirable to hide message windows as sensitive and/or personal information may be contained in these windows. Also, where an application provides a distracting or erratic interface, it can be desirable to hide the application's window. A further example of an application to be hidden is the task manager that can appear in a window on the desktop as the task manager generally provides administrative control over the computer. The presenter can select to open a dialog box (not shown) that presents a list of applications presently executing and select to hide specific applications by clicking on the application name. These settings for each application can be retained until the presenter elects to modify them. While this window may not contain sensitive information, it can be desirable to hatch the window in order to prevent providing viewers potentially with remote administrative privileges on the presenter's computer in situations where remote viewers are given remote control access.

Where a viewer has been given remote control access, the viewer can interact with the shared region of the presenter's desktop. The viewer's mouse events, including button clicking and movement, are handled as if they occurred on the presenter's computer. Such movement is limited to the shared region of the desktop. A rule set is provided to handle cases where two or more participants with remote control access are moving their mice. For example, where the presenter and a viewer with remote control access are simultaneously moving their mice, the viewer's mouse events are disregarded in favor of the mouse events of the presenter. Where two viewers with remote control access are simultaneously moving their mice, the viewer who was first to move his mouse is provided control of the pointer.

The viewers can elect to display the shared region 116 in a window or full screen. In either case, the shared region can be scaled accordingly or can be displayed in its original size. In this situation, scroll bars and other like navigational controls are provided to enable the viewers to view hidden portions of the shared region.

The color of the frame 120 of the GUI 100 changes for both the presenter and the viewers to reflect the control state of the presentation. When the presenter has selected to deny remote control access to viewers, the frame 120 appears in blue to the presenter and in green to the viewers. When the presenter has selected to grant remote control access to viewers, the frame 120 appears in red to the presenter and to the viewers.

The presenter can manually position the toolbar 124 at any point along the interior edge of the frame 120. When the presenter moves the toolbar 124, the toolbar 124 displayed to the viewers tracks the presenter's toolbar's movement. This allows the presenter to control what the viewers see to ensure that important information is not hidden.

Various balloon tips stemming from the toolbar 124 are provided during the course of a conference. The balloon tips announce when a participant has joined or left the conference as well as other important events. The participant has the option to turn off these balloon tips. In addition, audio cues can be optionally used in a similar manner, either alone or in conjunction with the balloon tips.

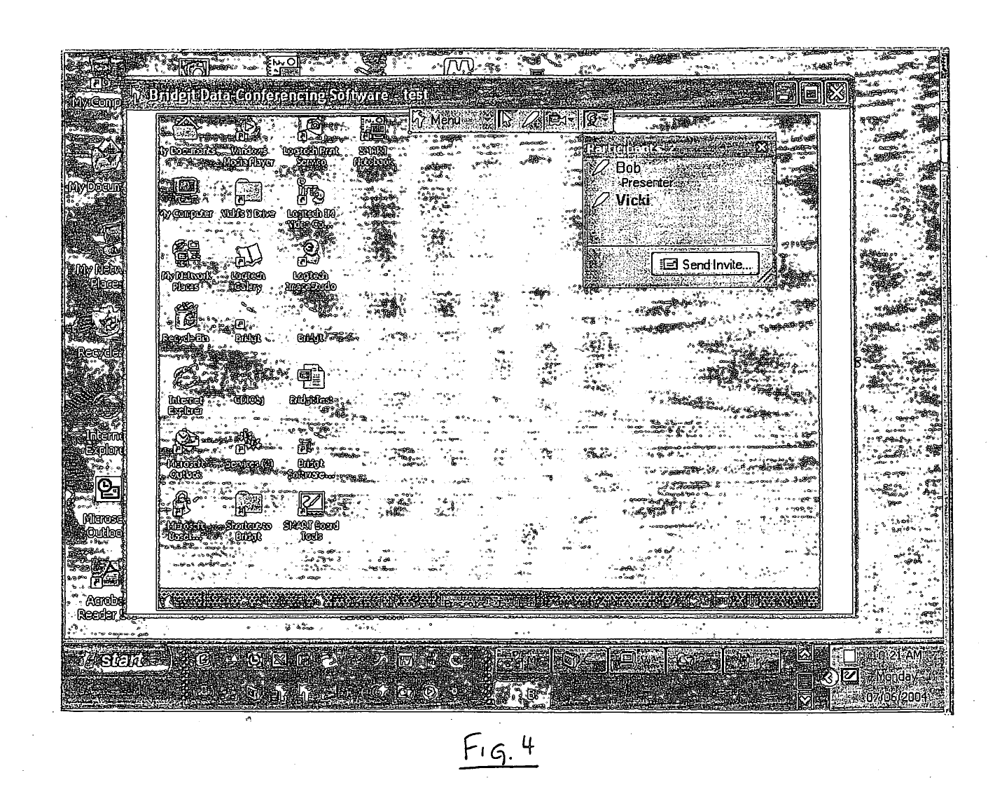

FIG. 4 shows the GUI 100 of the desktop sharing application presented to a viewer, wherein the presenter has opened a participants list 148 by clicking on the participants list button 144 in order to invite another participant to the conference. The participants list 148 lists the participants of the conference by name, indicating who is presenting, and includes a “send invite” button 152 for inviting other participants to the conference.

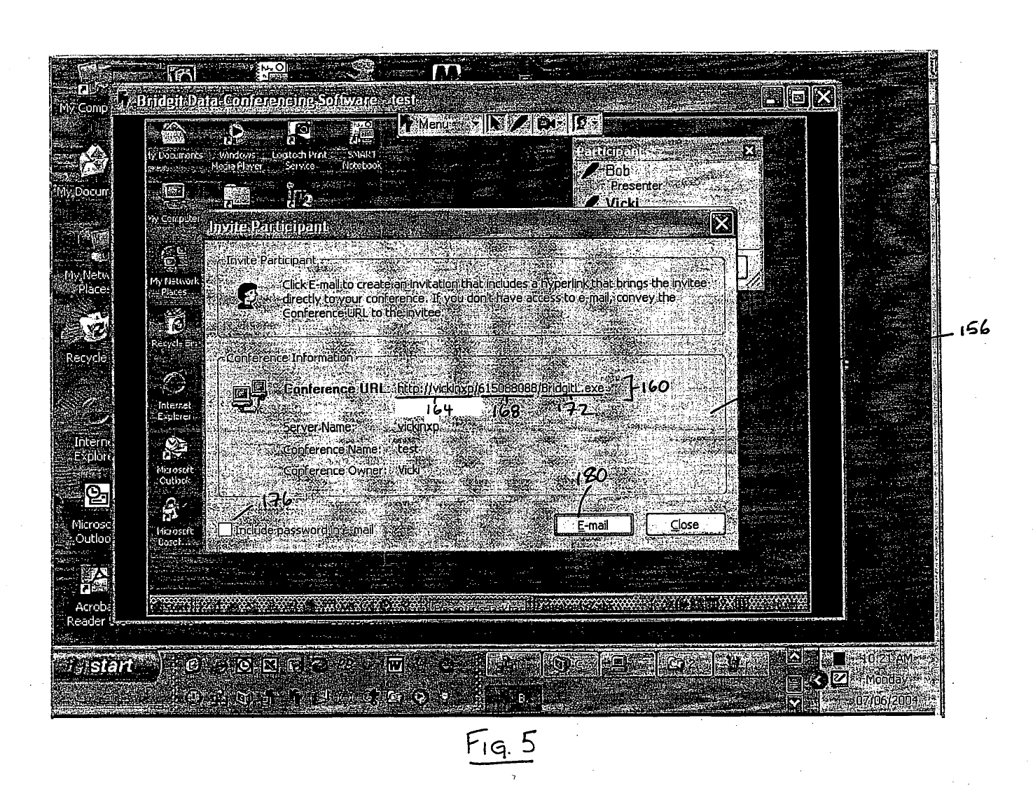

FIG. 5 shows a dialog box 156 that appears when the “send invite” button 152 is selected. The dialog box 156 displays a conference URL link 160 that includes the conferencing server's address 164, a conference ID 168, and a file reference link 172 to a loader application. The conference ID 168 is a unique identifier that is generated for the conference. Further, the dialog box 156 includes a checkbox 176 and an “E-mail” button 180. The checkbox 176 can be selected to include the password for the conference with an email that is sent to the invited participant, where a conference is password-protected. When the “E-mail” button 180 is selected, an email form is opened with the appropriate instructions. The conference URL 160 and the password for the conference, if appropriate, are inserted into the message body of the email form. As a result, in order to complete the invitation, a user only needs to insert the email address(es) of the conference invitee(s). The invitation is then ready to be sent.

When an invitee receives an emailed invitation, in order to join the conference, the invitee, after opening the email, simply needs to click on the conference URL link 160 presented in the email message. The conference URL link 160 refers to a file that is to be accessed via HyperText Transport Protocol (“HTTP”). As a result, the default Web browser is launched on the invitee's computer to download the specified file. When the Web browser connects to the conferencing server specified by the fully-qualified address 164, the conferencing server retrieves a browser cookie from the invitee's computer and inserts into it the address of the conferencing server 48 and the conference ID 168. The name of the browser cookie itself corresponds to the Internet address, either a fully-qualified domain name or an IP address, of the conferencing server. If the invitee's computer has never visited the conferencing server, the conferencing server will not find a corresponding browser cookie. As a result, the conferencing server creates a browser cookie and inserts into it a header identifying the cookie as storing the conferencing server's address and the conference ID, along with the address of the presenter's computer. The conferencing server then returns the browser cookie to the invitee's computer for storage in a browser cookie directory.

In addition, the conferencing server 48 returns a small loader application. When the loader application has been received by the invitee's computer and executed, it determines if the desktop sharing application has been installed on the invitee's computer. When the desktop sharing application is downloaded to a computer, it is stored by the loader application in a specific system directory. If the desktop sharing application is not detected in this system directory by the loader application, the loader application downloads the desktop sharing application from the conferencing server 48 and saves it to the specific system directory.

Once the desktop sharing application is located in the system directory, the loader application searches the directory in which browser cookies are maintained by the Web browser for the browser cookie associated with the conferencing server. As more than one conferencing server can exist, and each conferencing server is associated with a unique Internet address that is not known a priori, the loader application examines the browser cookies in the browser cookie directory in descending date order based on the modified date field until a browser cookie having a header identifying it as storing the conferencing server's address and the conference ID is located. While a Web site with which a Web browser is communicating can only retrieve its own browser cookie from the browser cookie directory of a computer, the loader application is able to access all of the cookies as it is executed locally on the invitee's computer.

When the most recently modified browser cookie that contains the conferencing server's address and the conference ID is located, the loader application reads and registers this information.

The loader application then launches the desktop sharing application via a command line command that includes the conferencing server's address and the conference ID as parameters. The desktop sharing application then uses this information to immediately connect to the conference specified by the parameters. As a result, the conference is connected to without requiring user input, such as manual entry of the conferencing server name and selection of the conference.

As the conference ID 168 is unique to the conference for which it was generated, subsequent attempts to use the information stored in the browser cookie to connect to the conference results in the desktop sharing application simply being connected to the conferencing server specified.

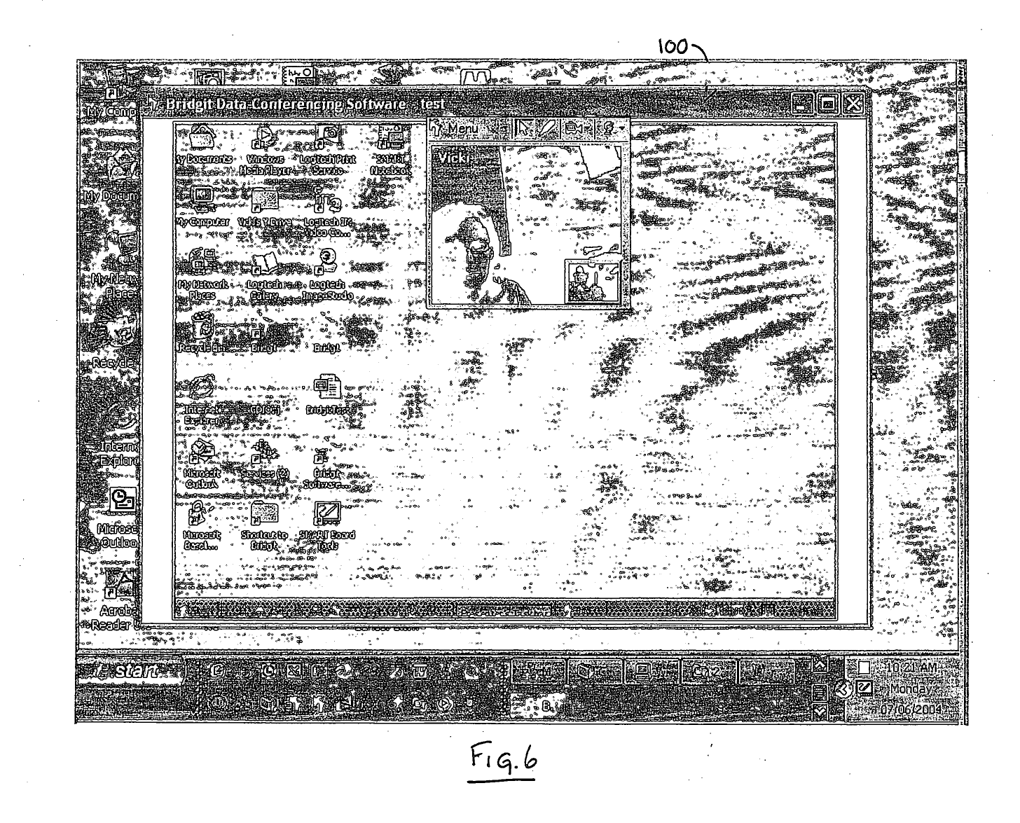

FIG. 6 shows the GUI 100, wherein a viewer has elected to view webcam video. A video frame 184 at least initially shows webcam video from a webcam beside the touch screen of the presenter. A sub-frame 188 initially shows webcam video from a webcam beside a viewer's personal computer. By selecting the sub-frame 188, the viewer can cause the source of webcam video for the sub-frame 188 to be switched with that of the video frame 184. This results in the display of webcam video from the presenter in the sub-frame 188 and the display of webcam video from the viewer in the frame 184. Where there are a number of participants with webcams, a number of sub-frames 188 are provided.

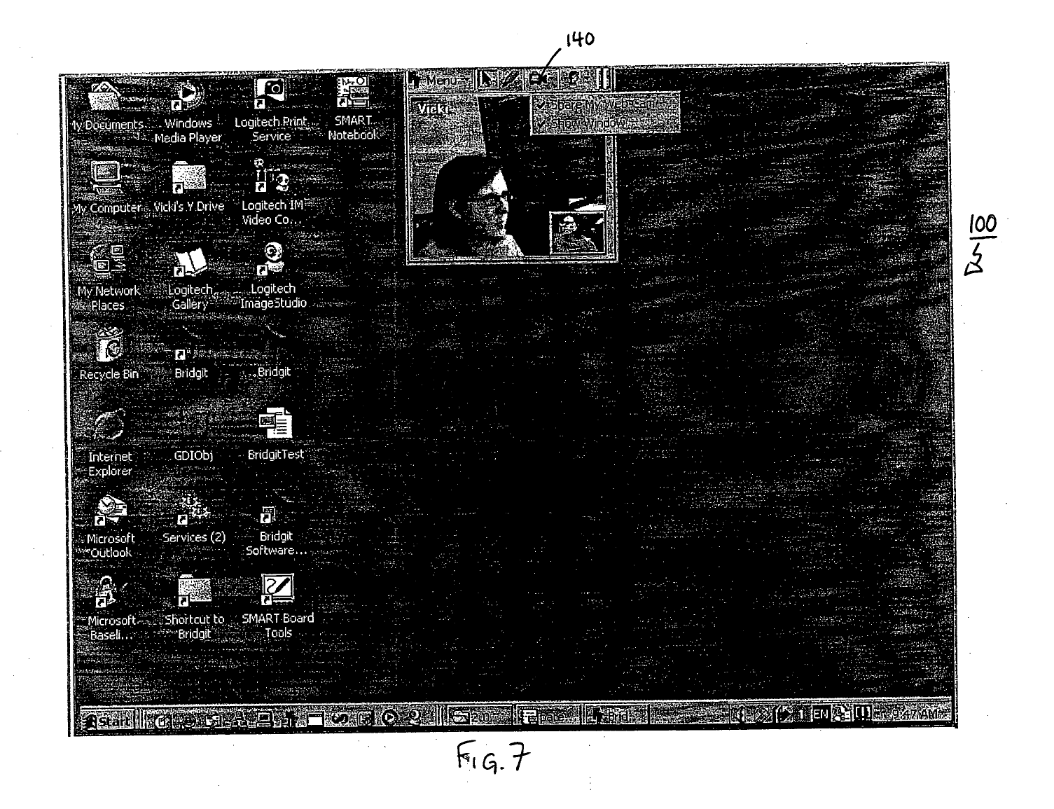

FIG. 7 shows the viewer's GUI 100 when the webcam menu button 140 has been selected to reveal a webcam menu 192. The webcam menu allows a participant to select whether to share his webcam video feed with other participants of the conference and whether to show or hide the video frame 184.

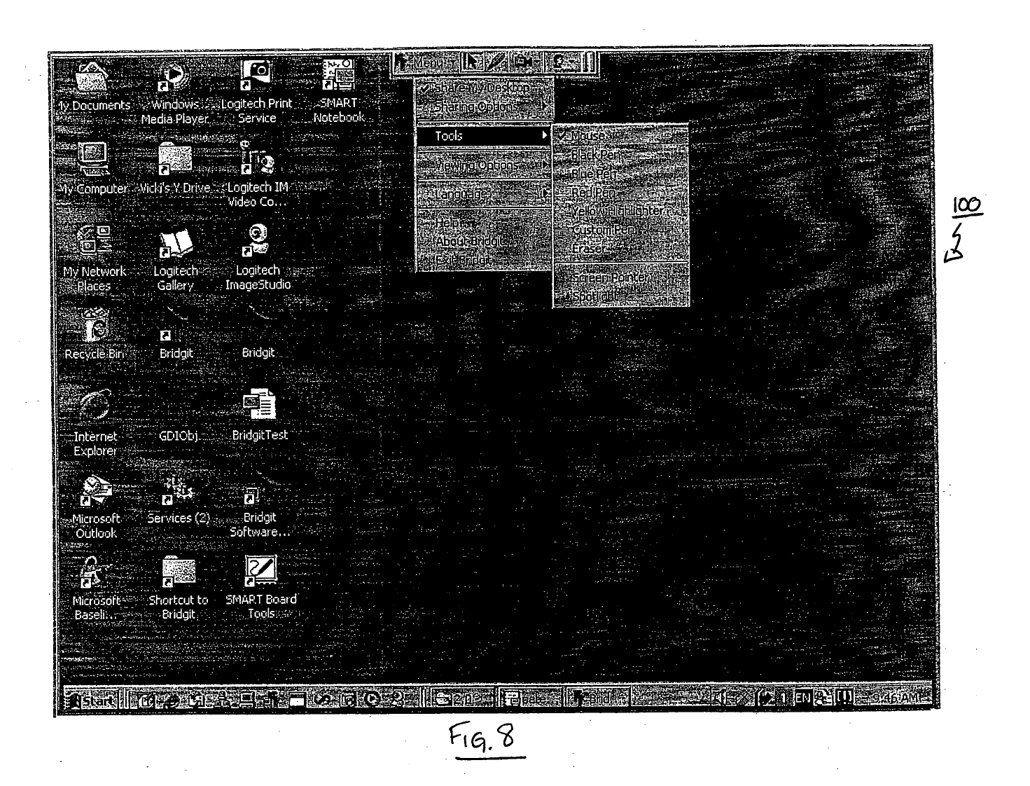

FIG. 8 shows the GUI 100 displayed to the presenter when the presenter has selected the “Tools” menu item from the main menu button 128. The sub-menu 196 revealed allows the presenter to select how the pointer input should be interpreted by the desktop sharing application. As illustrated, pointer input can be interpreted as mouse pointer movement, as one of a number of pens or markers, as an eraser, as a large arrowhead pointer or as a spotlight.

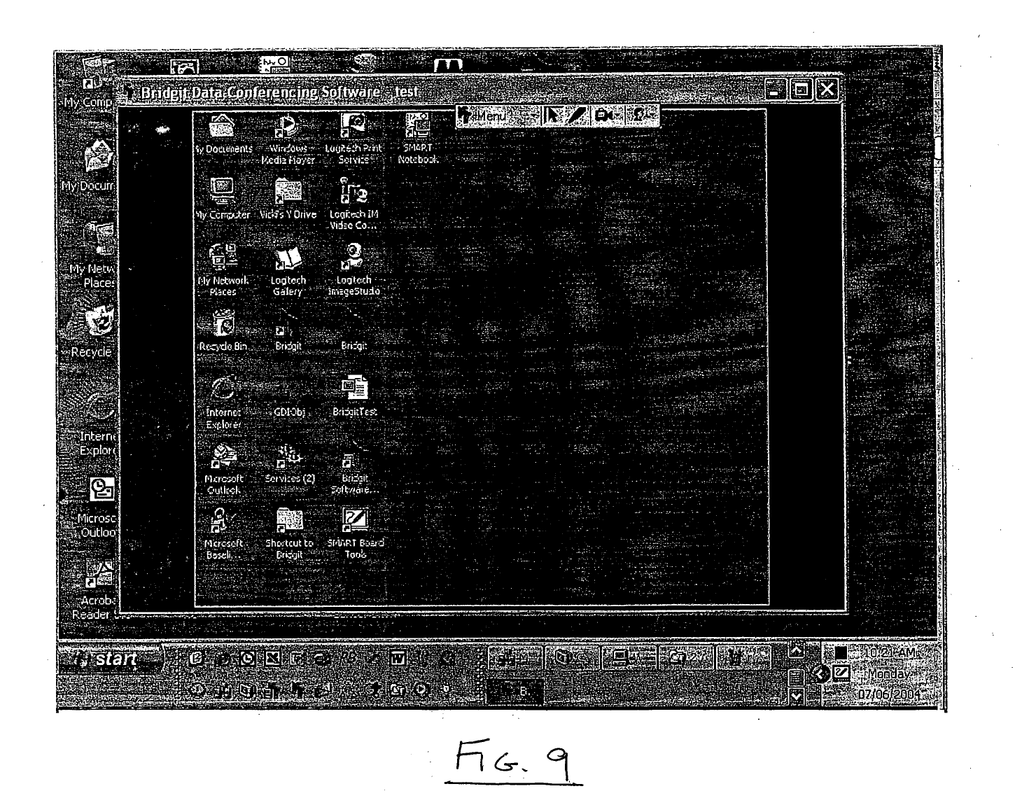

FIG. 9 shows the GUI 100 of FIG. 8 as seen by a viewer. As with the taskbar in FIGS. 3 to 6, the menu and submenu opened by the presenter are hatched to indicate that they are objects with which interaction is not possible.

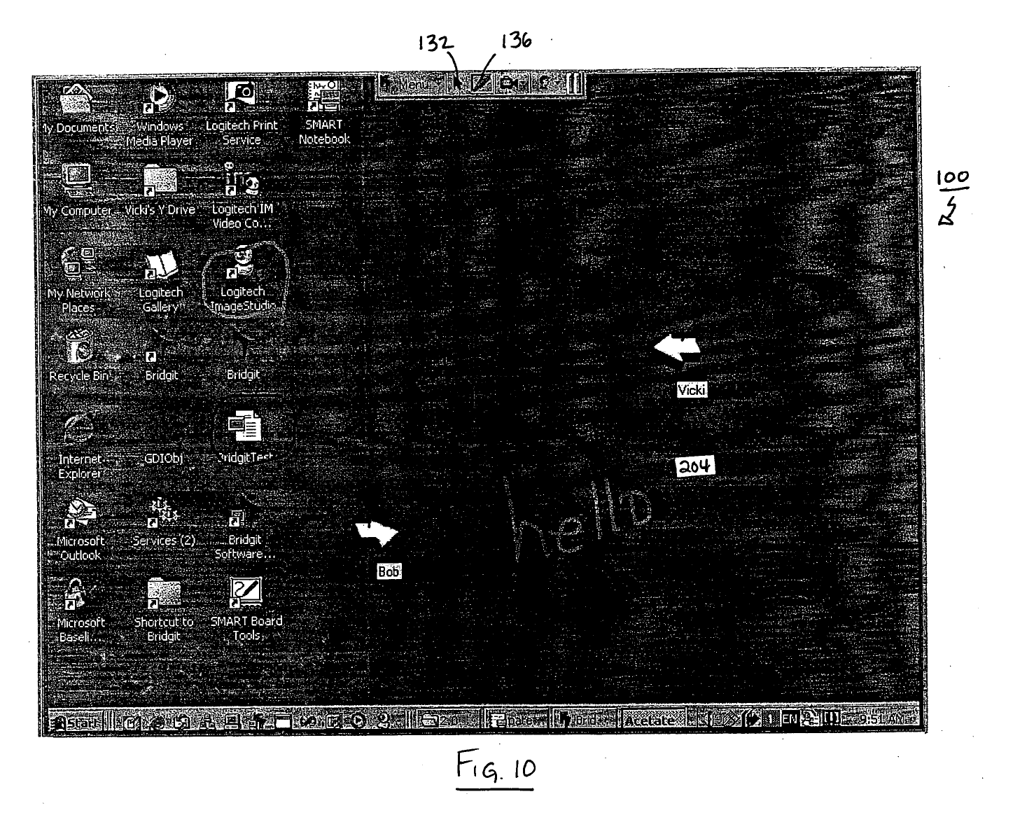

FIG. 10 shows the GUI 100 displayed to the presenter wherein the drawing option button 136 has been selected. In this example, an option to permit remote annotation by viewers under the “Sharing Options” sub-menu (not shown) of the main menu has been enabled. The desktop sharing application provides a transparent virtual acetate layer atop the shared region of the desktop that can be drawn on. As the presenter and the viewers annotate, the annotations are received and collectively drawn on the acetate layer. Both drawing 200 made by the presenter and drawing 204 made by a viewer appear on the shared region 116 at the same time, thus providing a shared area for annotation. Each user is, by default, assigned a distinct color for such drawing. The colors assigned to the participants are identified in the participants list, which can be exposed by selecting the participants list button 144.

In addition, in this example, both the presenter and the viewer have selected “Screen Pointer” from the “Tools” sub-menu of the main menu. As a result, a labeled arrowhead pointer 208 appears in the shared region 116, the position and orientation of which correspond to the position and last movement direction of the mouse pointer of the presenter. Also, a labeled arrowhead pointer 212 appears in the shared region 116, the position and orientation of which correspond to the position and last movement direction of the mouse pointer of the viewer. Any drawing made in the shared region is scaled accordingly if a participant is viewing the shared region in a reduced-size window.

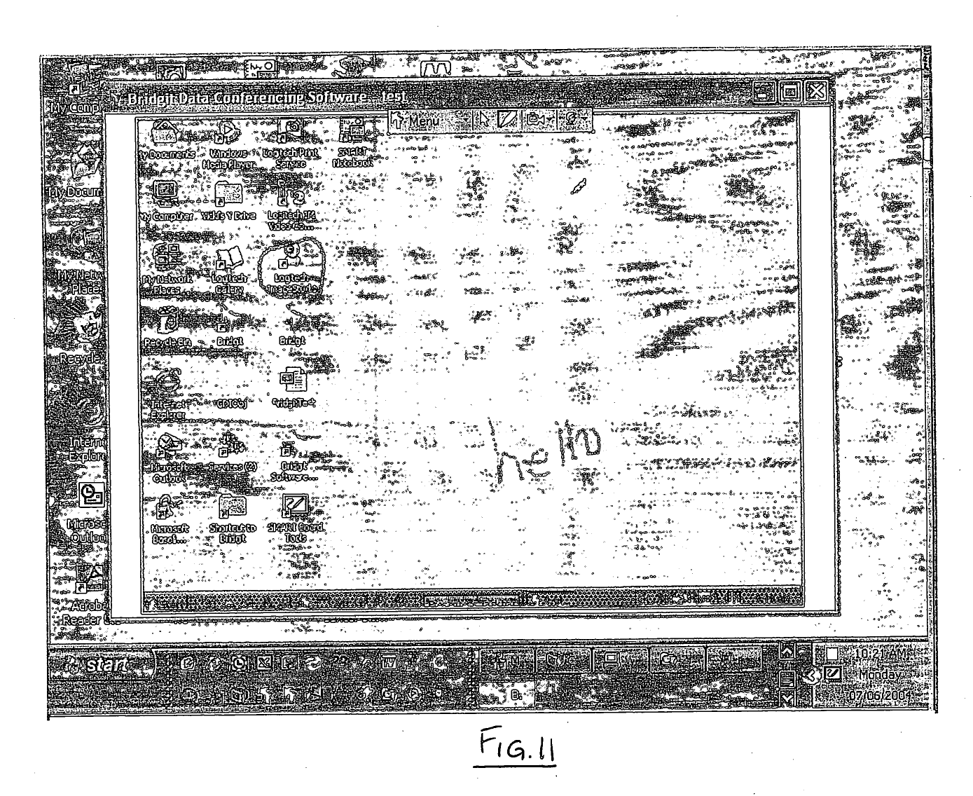

FIG. 11 shows the GUI 100 of FIG. 10 as seen by the viewer.

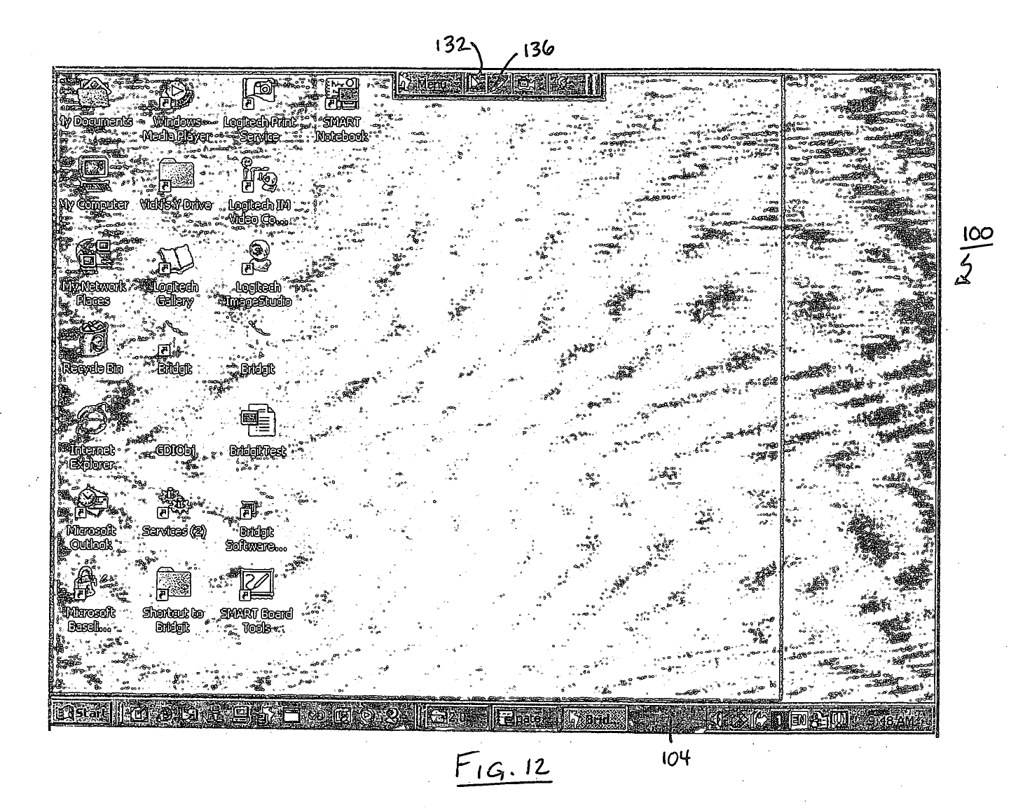

FIG. 12 shows the GUI 100 displayed to the presenter after having been resized by dragging the right portion of the frame left partially across the screen and the bottom portion of the frame up partially up the screen. The resulting shared region 116 no longer includes the taskbar 104. In some cases, it may be desirable to only display a portion of the desktop in order to maintain participant focus on a key area of the screen, to hide a portion of the screen which may contain sensitive information, or to reduce the network resource requirements of the desktop sharing application (by reducing the amount of information that is required to be transmitted to each participant). Further, sensitive controls can be hidden or made inaccessible to other participants.

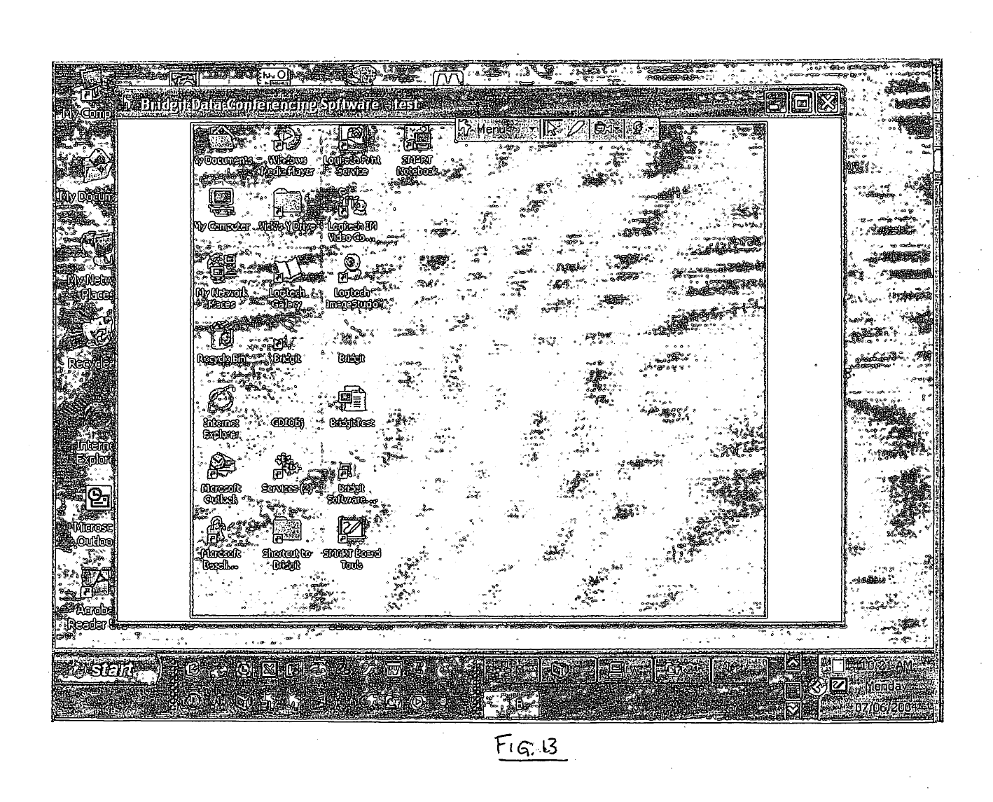

FIG. 13 shows the GUI 100 of FIG. 12 as seen by the viewer. As a result of the resize of the shared region, the shared region 116 of the GUI 100 does not include the presenter's taskbar and, thus, is not visible to the viewer.

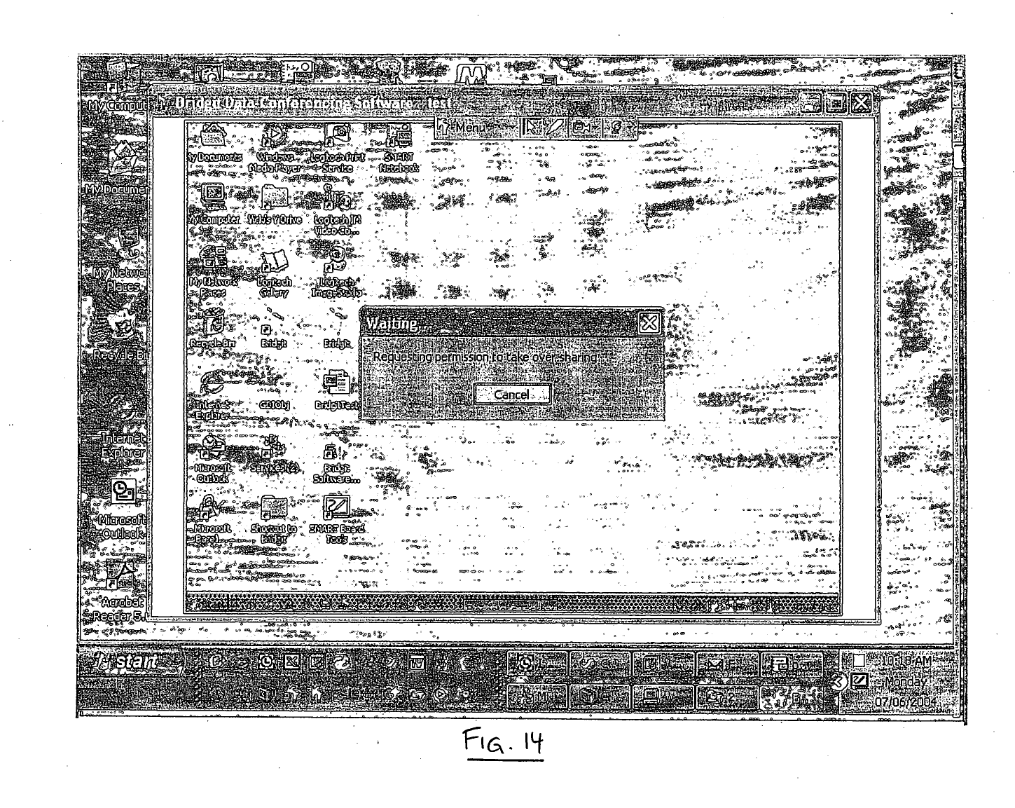

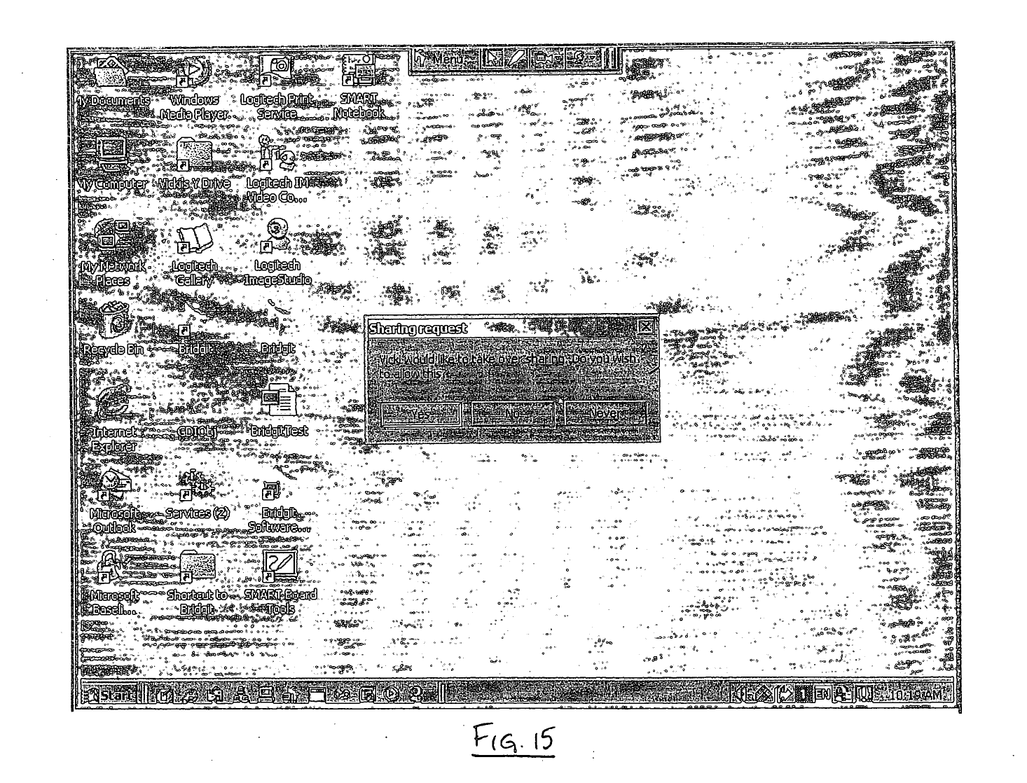

The desktop sharing application allows the role of presenter to shift to another participant in the conference. FIG. 14 shows the GUI 100 displayed to a viewer immediately after the viewer has requested to share his desktop. FIG. 15 shows the resulting GUI 100 displayed to the presenter. As can be seen, a dialog box appears to enable the presenter to permit or deny, either temporarily or for the duration of the conference, the viewer's request to share his desktop.

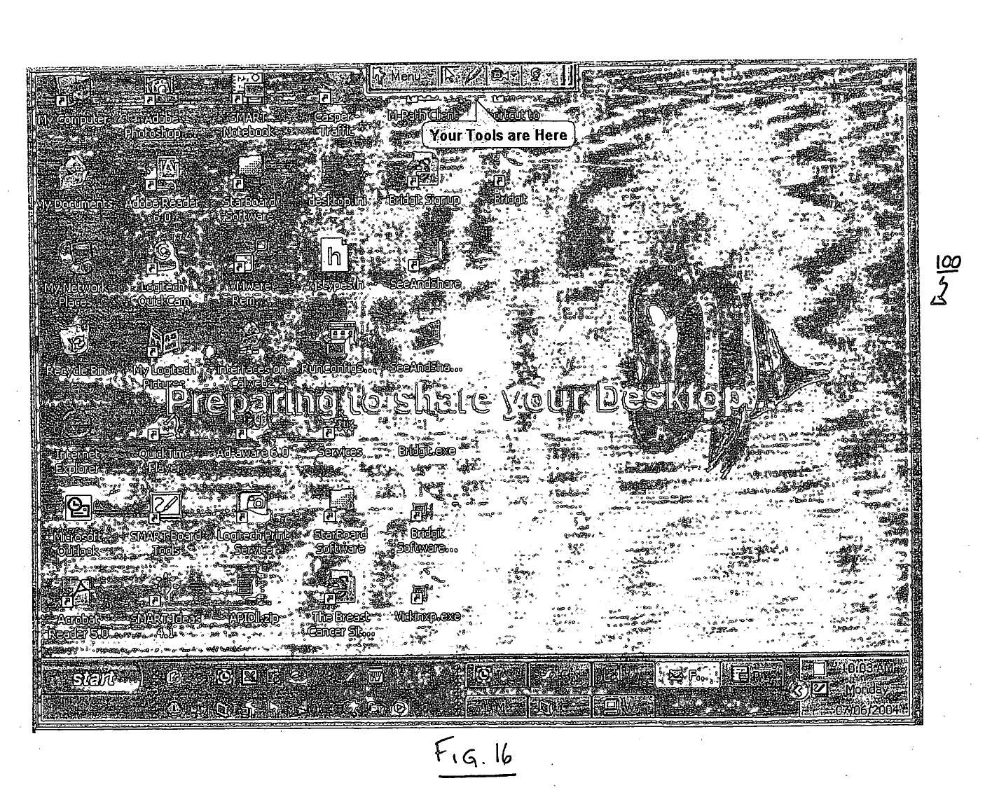

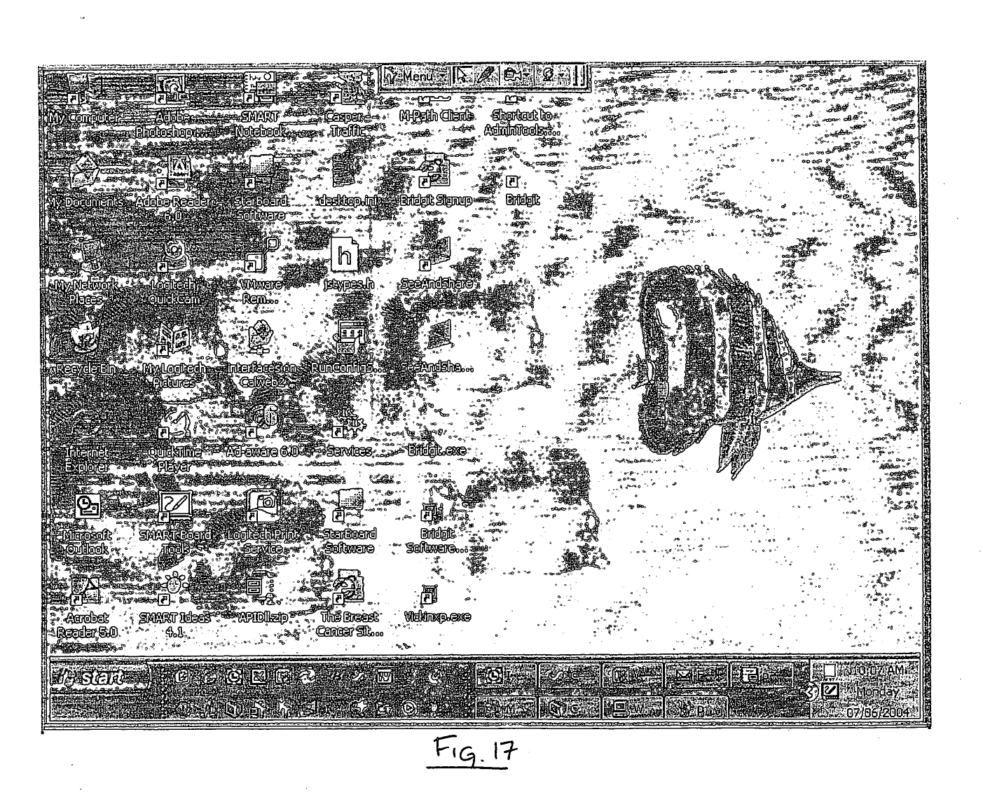

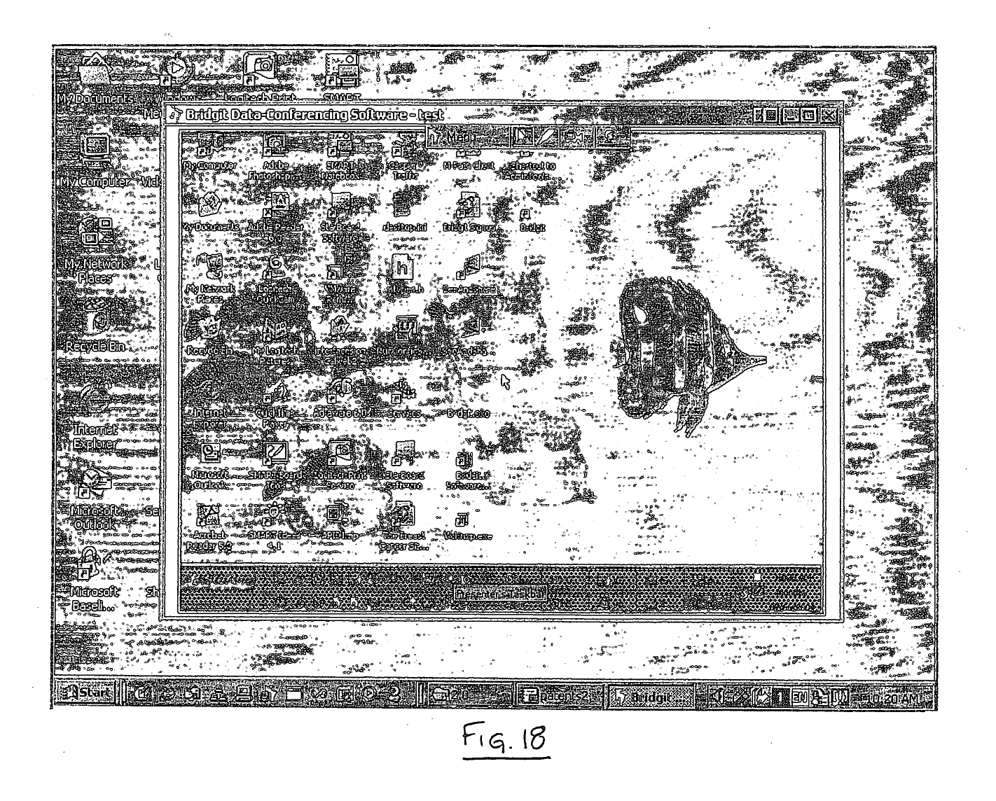

FIG. 16 shows the GUI 100 displayed to the viewer after the presenter has accepted the viewer's offer to share his desktop. A notification message 220 is displayed in the shared region 116. FIG. 17 shows the GUI 100 displayed to the viewer, now the presenter as a result of the transfer of control of the conference. The resulting GUI 100 displayed to the previous presenter, now a viewer, is shown in FIG. 18.

As network bandwidth is typically the most limited resource in the field of Internet conferencing, the desktop sharing application relies on a number of methods to reduce the amount of data transmitted to and from the conferencing server 48 by the computers 24a, 24b.

The principal method used by the desktop sharing application to reduce data transmissions is the division of the shared region into tiles, referred to hereinafter as tiling. Tiling generally reduces network resource utilization in two ways. First, only data for tiles of the shared region that change during successive shared region captures is transmitted. Second, by dividing the shared region into tiles, different compression techniques can be used to encode different sections of the shared region allowing compression techniques that are best suited to encode the data to be used.

The shared region is divided up into “tiles” of fixed size, in this example 84 pixels by 84 pixels. As the shared region is divided up into tiles from left to right and from top to bottom, some smaller tiles along the right and bottom edges can result.

Screen data is captured using one of two methods. In a first method, screen changes are detected using a dynamic link library (“DLL”) named Redraw Hooks. This DLL is dynamically downloaded from the conferencing server 48 when required and hooks into window calls to report what areas of the screen have been redrawn.

In a second method, a mirror driver can be downloaded and installed. The mirror driver is a device driver that is dynamically installed to overcome issues associated with hardware acceleration. The mirror driver hooks Graphical Device Interface (“GDI”) calls and reports screen changes.

In some circumstances, the first and second methods of capturing screen data are not available. In this case, the entire screen is analyzed to determine what areas have changed.

Using one of these three methods, the shared region is monitored to detect changes therein. Updated screen information is only transmitted from the host computer to the client computers via the conferencing server 48 for tiles that have changed.

In order to reduce the amount of information being transmitted across the network, the tile image data is compressed prior to transmission. Two types of compression are employed, namely JPEG and Camtasia Studio, hereinafter referred to as Camtasia. JPEG compression is lossy but compresses high color images better than Camtasia. As a result, JPEG compression is suitable for use with photographs or complex images having a high level of detail and/or a large number of colors. Using JPEG compression can provide a significant reduction in the amount of data with little perceived effect on the quality of the image. In contrast, Camtasia compression is lossless. As a result, Camtasia is suited for preserving sharp details in a geometric image while providing a high reduction in file size. As different areas of the shared region can have significantly different content, selection of a single compression type for the entire shared region can yield poor results in some circumstances, either due to less than desirable compression or due to image data loss. By addressing each tile separately, the compression can be fine-tuned for each area of the shared region.

In addition, Camtasia compression permits image data to be sent as an initial frame, or keyframe, or, alternatively, as a delta. A keyframe is a Camtasia image that provides an initial frame of image data, or “snapshot”, representing the shared region. In the present system, the keyframe is blacked out for tiles selected for jpeg compression and is also sometimes blacked out for unchanged regions. The delta is image data representing changes in the non-jpeg tiles in subsequent frames. While the keyframe can be assembled together with the tiles selected for jpeg compression to represent a frame, a delta is applied to the last keyframe and any intermediate deltas, along with any tiles selected for jpeg compression, in order to represent a frame.

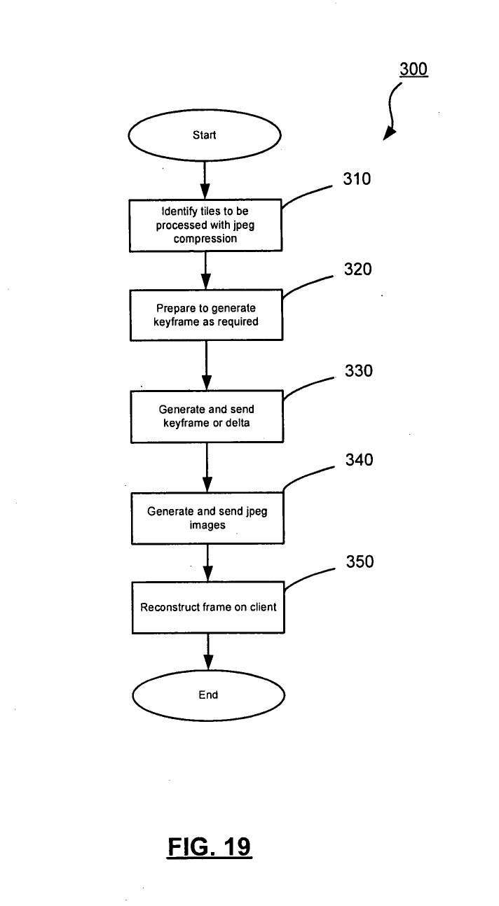

The general method 300 of compressing, sending and reconstructing frames of the shared region is illustrated in FIG. 19. At 310, tiles that are to be processed with jpeg compression are identified by the host computer. Then, preparation is made to generate a keyframe as required at 320. Those tiles of the shared region that have been identified for jpeg compression are ignored in the preparation of Camtasia images as they will be sent separately. Once a keyframe has been generated and sent, delta images identifying only the differences between subsequent frames can be generated by the host computer and sent to the client computers for reconstruction.

At 330, a keyframe or delta is generated and sent by the host computer. Next, at 340, jpeg images are generated and sent for those tiles identified for jpeg compression at 310. The current frame is then reconstructed by the client computers at 350.

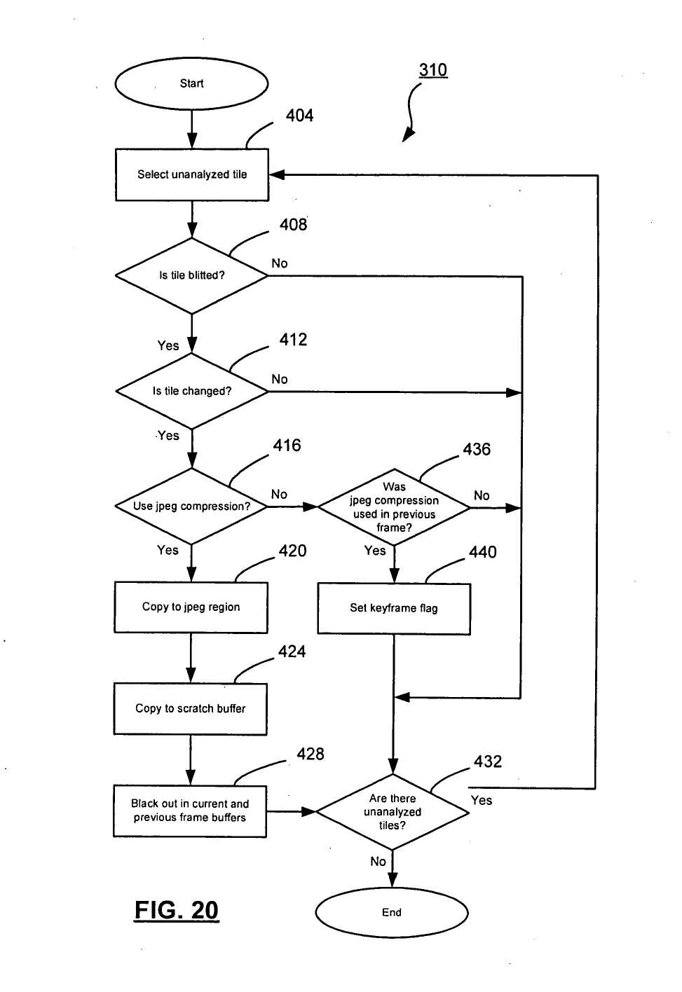

FIG. 20 better illustrates the identification of tiles for jpeg compression 310. At 404, a tile from a frame is selected for analysis. It is determined whether the tile has been blitted, or written to screen, indicating a possible change in the image data. If the tile was blitted, at 408, it is determined whether the tile has changed since the last frame. This is done by performing a raw memory comparison of the tile from the current frame to that of the last frame. If the tile is from an initial frame, it is assumed that the tile has “changed”.

If the tile has changed since the last frame, the method proceeds to 416, wherein it is determined whether jpeg compression is to be used for the tile. In order to determine which compression type is to be used, for each changed tile, pixels are randomly sampled from the tile and processed using an algorithm to determine which of the two image compression types would likely yield better compression without significantly affecting the quality of the image. In particular, 32 pixels are sampled from the tile to determine if more than 12 vary in color from each other. By determining the more appropriate compression type to be used based on a small random sample of pixels, rather than by comparing the size of the image compressed using both compression types, processor utilization is reduced. It has been found that by using a random sample size of 32 pixels, the selected compression type is correct in most typical circumstances for regular desktop application use.

If high color variation is present in the tile, it is assumed that the tile is better suited for jpeg compression. At 420, the tile is copied to a jpeg region for processing at a later time. The tile is also copied to a scratch buffer at 424. A scratch buffer is a temporary location in memory used as a work area. The tile is then blacked out in the current and previous frame buffers at 428. Then, at 432, it is determined whether there are any tiles from the current frame buffer that have not been analyzed.

If, instead, it is determined that jpeg compression is not to be used for the tile at 416, the method proceeds to 436, wherein it is determined whether jpeg compression was used for the tile in the previous frame. If the tile was previously processed using jpeg compression and it has been determined that jpeg compression will not be used for the tile in the current frame, a keyframe flag is set at 440, indicating that a keyframe is to be generated. As the tile in this case had been blacked out in the previous frame, the Camtasia delta for the current frame would generally need to contain data for the entire tile as the tile had been blacked out previously. The method then proceeds to 432, wherein it is determined whether there are any files from the current frame that have not been analyzed.

If, at 432, it is determined there are unanalyzed tiles, the method returns to 404, wherein another tile is selected for analysis. Otherwise, the method ends.

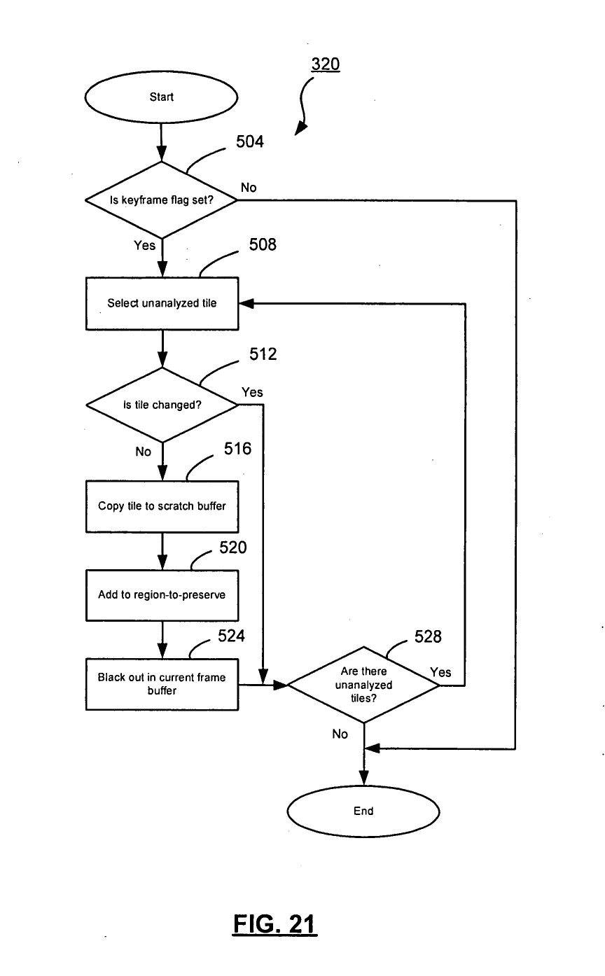

If, in fact, a tile was processed using jpeg compression in the previous frame and is identified for processing using Camtasia compression in the current frame, or if the current frame is the initial frame, a keyframe is generated. FIG. 21 illustrates the method 320 of preparing to generate a keyframe, as required. The method 320 commences at 504, wherein it is determined whether the keyframe flag has been set, indicating that a keyframe is to be generated. If the keyframe is not set, the method 320 ends.

If, at 504, the keyframe flag is set, the method 320 proceeds to 508, wherein an unanalyzed tile is selected from the current frame. At 512, it is determined whether the tile has changed using the same general approach as used at 412. If the tile has changed, the method proceeds to 516, where it is determined whether there are unanalyzed tiles in the current frame.

If the tile has not changed, the method proceeds to 520, wherein the tile is copied to the scratch buffer. Then, at 524, the tile is added to the region-to-preserve, a list of tiles that have not changed. At 528, the tile is blacked out of the current frame buffer. The method then proceeds to 516, where it is determined whether there are unanalyzed tiles in the current frame. If there are unanalyzed tiles in the current frame, the method returns to 508, where another tile is selected for analysis. If there are no other tiles for analysis in the current frame, the method 320 ends.

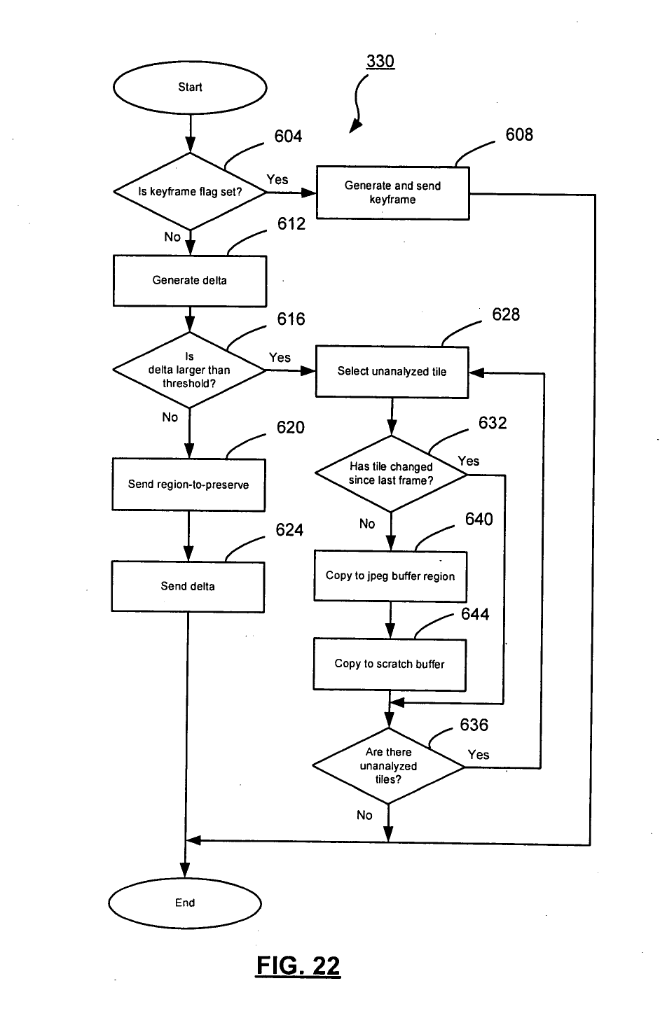

Once each tile of the current frame has been analyzed to determine the compression type to be used, a Camtasia keyframe or delta is generated and sent. FIG. 22 better illustrates the method of generating and sending a keyframe or delta. At 604, it is determined whether the keyframe flag has been set, thus indicating that a keyframe is to be generated. If it is determined that the keyframe flag is set, the method proceeds to 608, where a keyframe is generated and sent.

If, at 604, it is determined that the keyframe flag has not been set, the method 330 proceeds to 612, where a Camtasia delta is generated. It is then determined if the Camtasia delta is larger than a desired threshold at 616. The threshold is set equal to one-third of the total size of the shared region as a raw image multiplied by the portion of the shared region that the Camtasia delta represents, and is selected to approximate the “break-even” point for using jpeg compression. If it is determined that the size of the Camtasia delta is smaller than the threshold at 616, the method 330 proceeds to 620, where the frame is sent to region-to-preserve. Then, at 624, the Camtasia delta is sent by the host computer to the client computers, after which the method 330 ends.

If, instead, the Camtasia delta is determined to be larger than the threshold at 616, the method 330 proceeds to 628, where a tile is selected from the frame for analysis. At 632, it is determined whether the tile has changed since the previous frame, again using the same general approach discussed with respect to 408 above. If it is determined that the tile has changed, the method proceeds to 636, where it is determined whether there remain any unanalyzed tiles. If, instead, it is determined that the tile has not changed, the tile is copied to the jpeg region at 640. Then, at 644, the tile is copied to the scratch buffer, before determining whether there remain any unanalyzed tiles at 636. If it is determined at 636 that there are unanalyzed tiles in the current frame, the method returns to 628, where another tile is selected for analysis. If there are no further tiles in the frame, the method 330 ends.

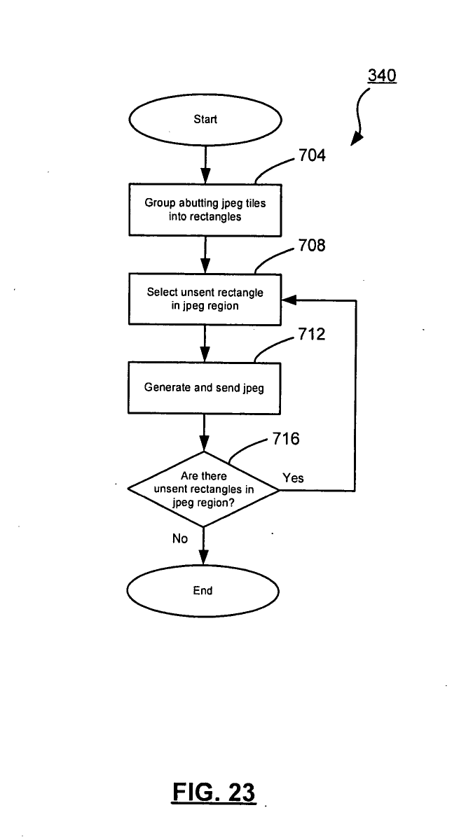

Once all of the tiles that are processed using Camtasia compression have been sent, the tiles identified for jpeg compression are compressed and sent to the client computers at 340. FIG. 23 better illustrates the method 340. First, abutting tiles to be compressed using jpeg compression are grouped into rectangles at 704. At 708, an unsent tile is selected from the jpeg region. The tile is compressed using jpeg compression and sent to the client computers at 712. Then, at 716, if there are unsent tiles in the jpeg region, the method 340 returns to 708 for compression and sending of another tile in the jpeg region. If, instead, no other tiles remain in the jpeg region, the method 340 ends.

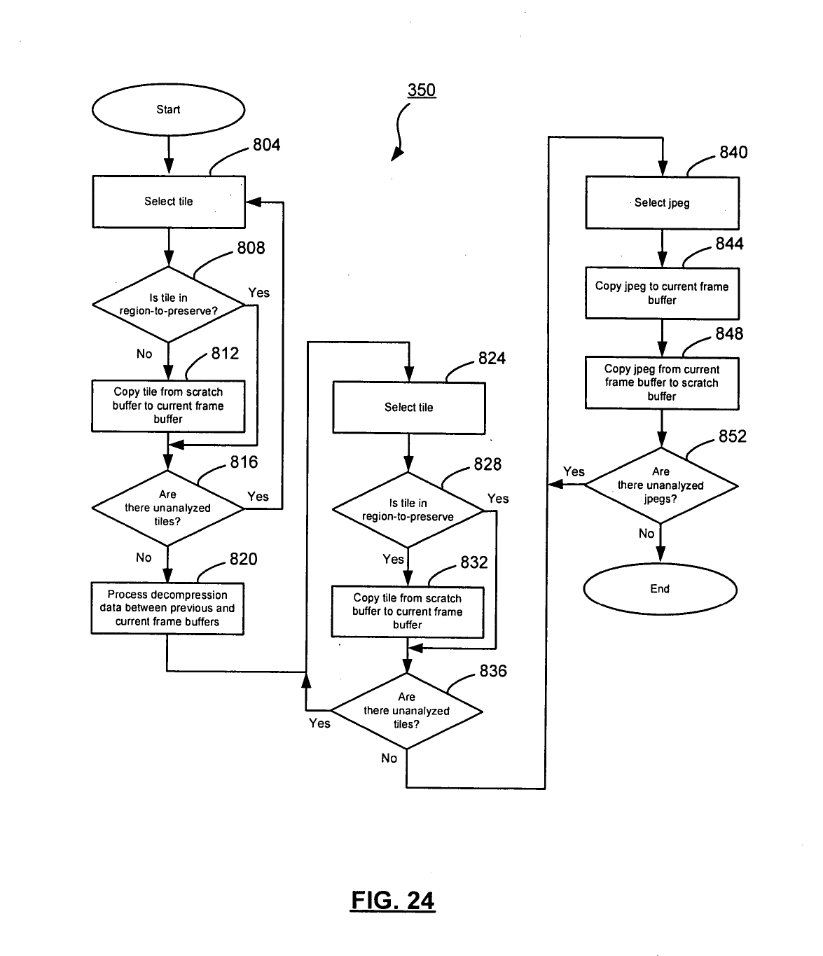

Once all of the data has been compressed and sent to the client computers, the client computers must reconstruct the frame from the transmitted data. The method 350 of reconstructing the frame is better illustrated with reference to FIG. 24. At 804, a tile is selected and, at 808, it is determined whether the tile is in the region-to-preserve. If it is not, the tile is copied from the scratch buffer to the current frame buffer at 812. At 816, it is determined whether there are any unanalyzed tiles. If there are, the method returns to 804, where another tile is selected, otherwise the method proceeds to 820, where the keyframe or delta, whichever was sent, is processed. The resulting tiles are written to the current frame buffer.

The method then proceeds to 824, where a tile is selected. At 828, it is determined whether the tile is in the region-to-preserve. If the tile is in the region-to-preserve, the tile is copied from the scratch buffer to the current frame buffer at 832. At 836, it is determined whether there are any unanalyzed tiles. If there are, the method returns to 824, where another tile is selected. If there are no other unanalyzed tiles, the method proceeds to 840, where a jpeg is selected. At 844, the jpeg is copied into the current frame buffer. Then, the jpeg is copied from the current frame buffer to the scratch buffer at 848. At 852, it is determined whether there are any jpegs remaining to be analyzed. If there are, the method returns to 840, where another jpeg is selected. If not, the method ends.

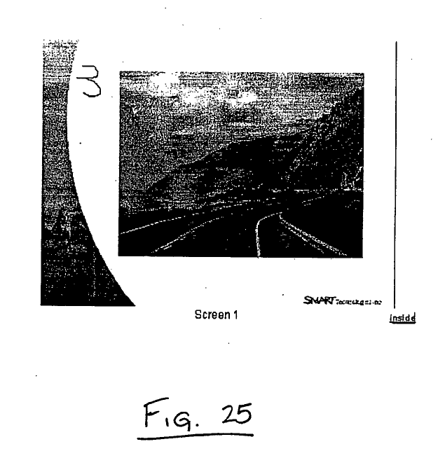

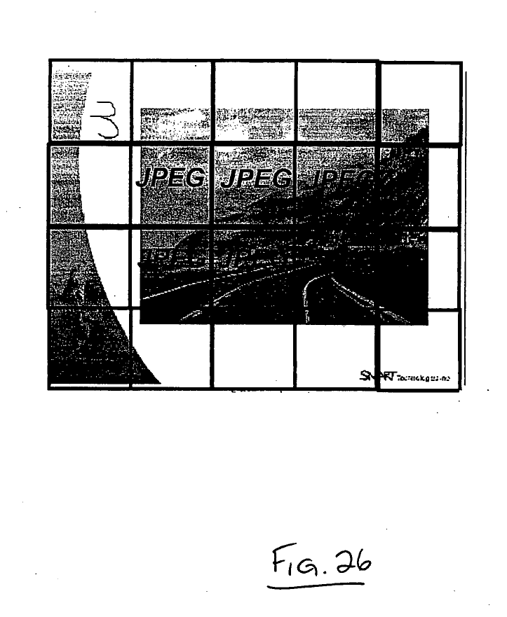

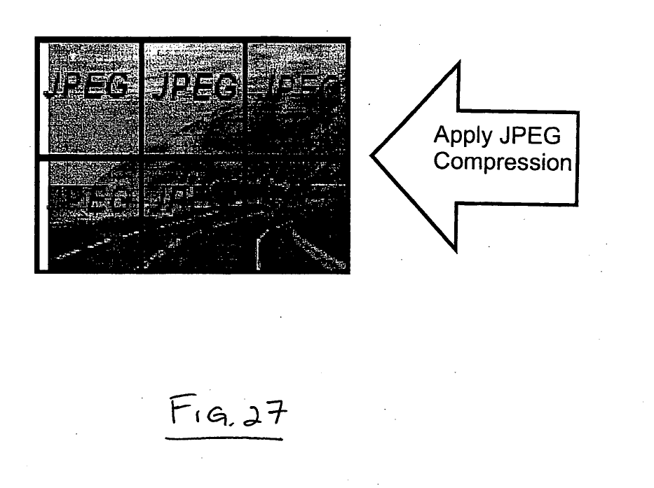

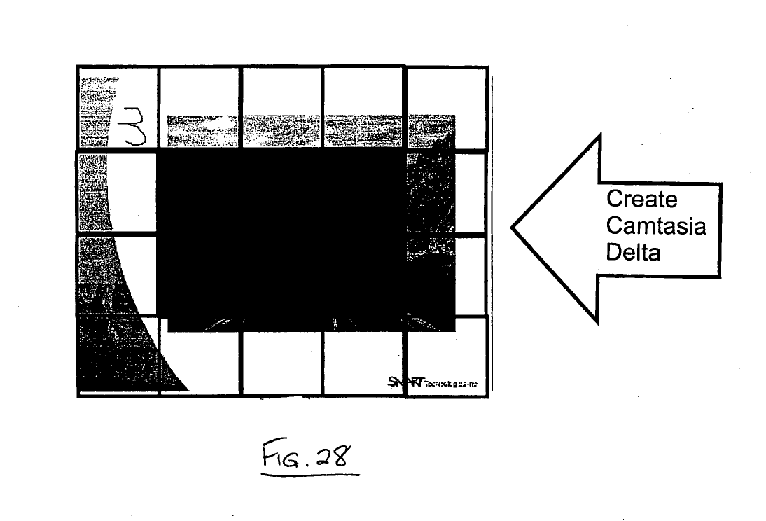

FIG. 25 shows an image presented in a shared region. The image is, in effect, a frame that consists of a generally solid-colored background with a photograph in the foreground. FIG. 26 shows the same frame having been divided into tiles. Due to the color variation in the tiles that are spanned by the photograph, JPEG compression is selected for these tiles. The JPEG images for these tiles shown in FIG. 27 are registered and then blacked out of the frame presented in the shared region. FIG. 28 shows the remaining tiles that are compressed using Camtasia compression. A Camtasia compress is then performed on this frame to yield a delta between this frame and a previous frame. As the replaced tiles are blacked out, these tiles contribute no data to the Camtasia delta. The above method thus yields a JPEG image for certain tiles and a Camtasia delta for the entire shared region frame (with the JPEG-related tiles blackened). The JPEG tile image and the Camtasia delta data are transmitted to viewers for display.

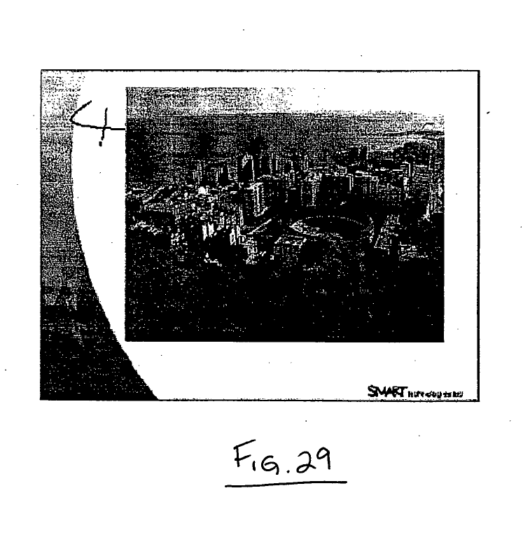

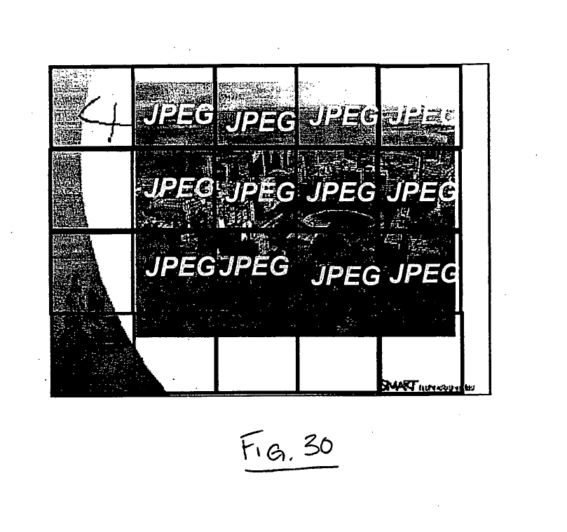

FIG. 29 shows another frame of the shared region to be transmitted after the frame shown in FIG. 25. The shared region, in this case, includes a photograph to the center-right. FIG. 30 shows the shared region of FIG. 29 after tiling of the frame and determining which tiles are best suited for JPEG compression. These tiles are converted to JPEG images and a Camtasia delta is generated for the entire shared region with the JPEG tiles blacked out. As the four tiles along the left edge of the shared region have not changed when compared to the previous frame presented in the shared region (i.e. that of FIG. 25), the Camtasia delta yields no change for these tiles. The remaining four tiles along the bottom edge of the shared region have changed and, as a result, Camtasia delta data exists for these tiles. The JPEG tile images and the Camtasia delta data are similarly transmitted to the viewers. The desktop sharing applications receiving the transmitted JPEG tile images and Camtasia delta data then understands that no change has occurred in the left-most tiles of the shared region.

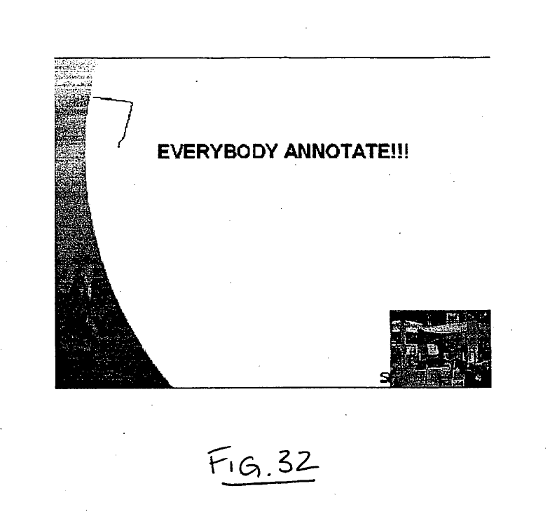

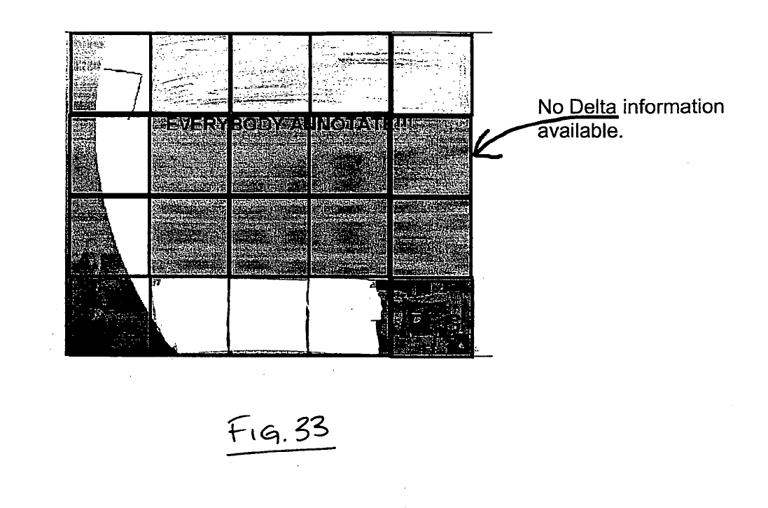

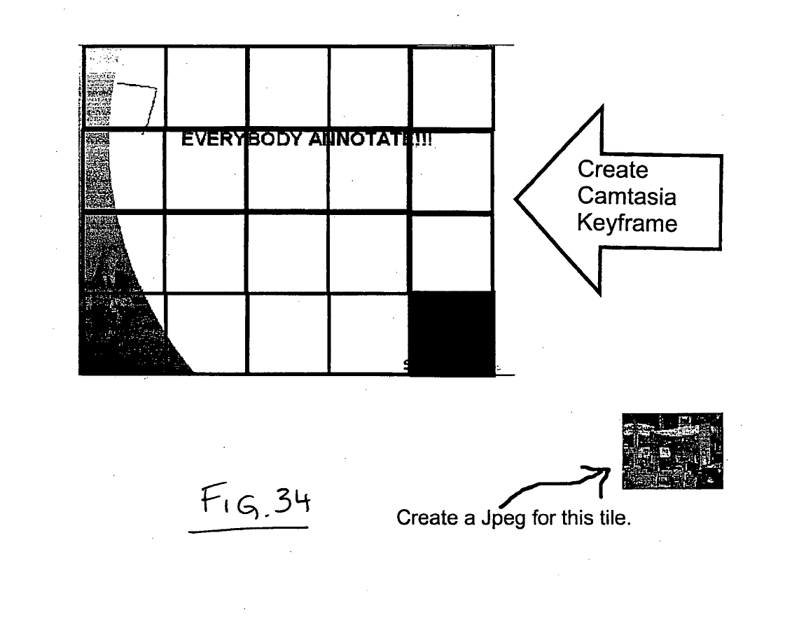

FIG. 32 shows yet another image presented in the shared region to be transmitted. The shared region, in this case, primarily consists of solid background with a small photograph in the lower-right corner. After tiling the shared region, only the lower-right tile is identified for JPEG compression as shown in FIG. 33. This single tile is blacked out of the frame captured from the shared region and a Camtasia delta is generated. Once again, the four left-most tiles have not changed when compared to the previous frame. The shaded-in tiles represent tiles that previously contained image data that was compressed using JPEG compression. As a result, no Camtasia data is available for the shaded-in tiles. To deal with this situation, a new keyframe consisting of all tiles of the image that are not to be compressed with JPEG compression is captured as shown in FIG. 34. The keyframe provides a starting point for subsequent Camtasia deltas. The JPEG image corresponding to the photograph at the bottom-right of the image is transmitted to the conferencing server 48 along with the keyframe for retransmission to the viewers.

JPEG images corresponding to tiles are cached by the desktop sharing applications. As a result, for tiles for which JPEG compression is employed, the presenter's desktop sharing application simply directs the other desktop sharing applications to reuse the same JPEG for a particular tile.

The overall conferencing experience is further improved by controlling the amount of webcam video feed data in comparison to the amount of screen data transmitted to each participant. The principal way in which this is achieved is by controlling the maximum frame-rate of webcam video that is transmitted between the participants. Further, where a number of webcam video feeds are being presented via a frame and sub-frames, it can be desirable to reduce the frame-rate transmitted for the sub-frames in relation to the frame as motion in the smaller sub-frames can be less noticeable.

It can be desirable in some cases to permit the presenter and/or viewers to control the ratio of screen data to webcam video data. Where one or more participants have poor network connectivity, the frame-rate for these participants can be adjusted accordingly or webcam sharing can be turned off altogether for them.

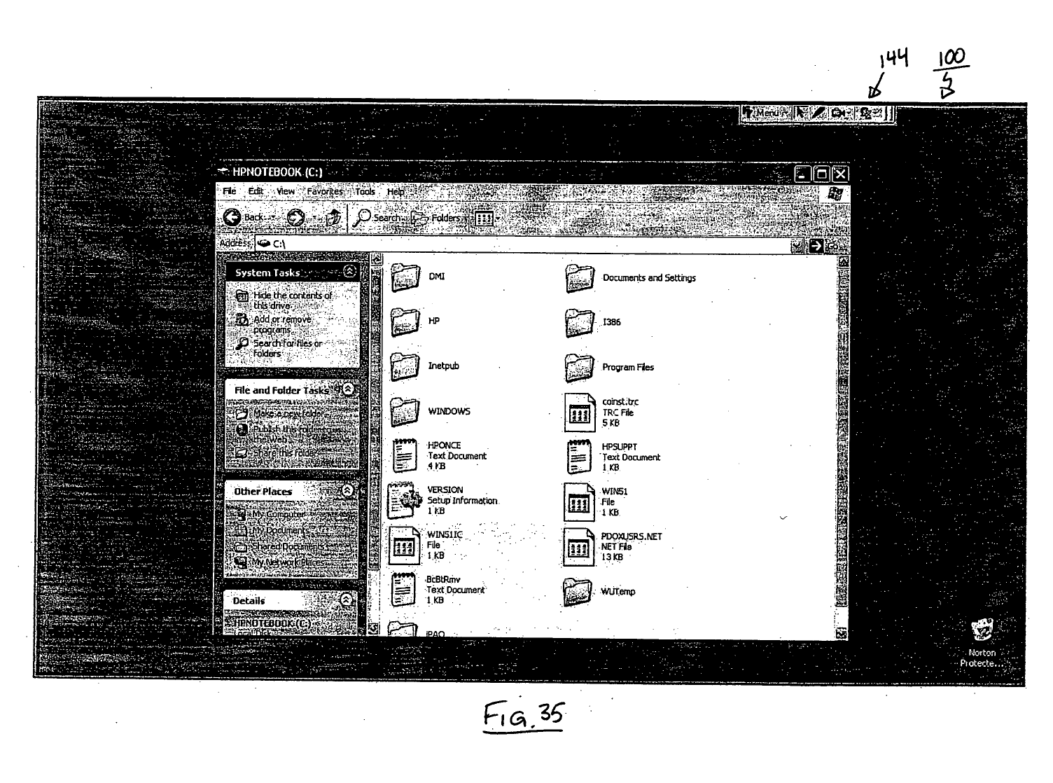

While these techniques enhance the overall conference experience by reducing data to be transmitted between desktop sharing applications, situations can arise where the network resources are less than desirable, causing one or more participants to lag behind in the presentation or to be disconnected altogether. The desktop sharing application provides additional functionality to address these situations.

Where one or more participants have less than desirable network connections, they may fall behind in receiving the presentation. As some of the screen data sent is in Camtasia delta format, the screen data can only be interpreted in relation to the previous set of transmitted screen data. As a result, all of the transmitted screen data must be received and interpreted sequentially, which can cause delays where network resources are diminished. In order to make the presenter aware of this situation, if it occurs, an indicator is provided to the presenter. FIG. 35 shows the GUI 100 displayed to the presenter when one or more participants are lagging behind. In this case, the image on the participants list button 144 is dynamically altered to include an hourglass. When the participants list button 144 is selected to reveal the list of the participants, an hourglass will appear beside the name of each participant currently lagging behind in the conference. The hourglass is outlined in red if a participant lags more than 15 seconds behind. The participants list button 144 displayed to each viewer that is lagging behind is also dynamically changed to indicate to the viewer that he has fallen behind in the conference.

When the desktop sharing application running on the host computer determines that a client computer is lagging by 30 seconds or more, the desktop sharing application triggers a Camtasia keyframe to be generated and forwarded to the lagging client computer by setting the keyframe flag. The keyframe is a complete screen data frame of absolute values. As the values are absolute, the desktop sharing applications can receive the keyframe and display it immediately without performing a sequential build of the screen. At the same time, JPEG images are transmitted for any tiles that have been selected for JPEG compression where necessary (i.e. if the images are not cached by the desktop sharing application). All other pending screen changes for the lagging client computer are purged.

In addition, where a participant's desktop sharing application has been disconnected from the conference intentionally, accidentally, or as a result of limited network resources, it is desirable to start the participant at the currently displayed screen data. Upon detecting that a participant has joined the conference, the desktop sharing application generates a Camtasia keyframe and JPEG image set and transmits this information to the new participant. Upon receiving the Camtasia keyframe and JPEG image set, the participant's desktop sharing application can display the current shared region and interpret any new Camtasia delta data transmitted.

In order to allow users to quickly download the desktop sharing application, various components are bundled as dynamic link libraries that are downloaded by the desktop sharing application as they are required. For example, the mirror driver used to capture screen data is an optional component that is downloaded by the desktop sharing application as needed.

Further, language packs can be installed on the fly. If the desktop sharing application detects that it does not have a language pack for the local language of the computer upon which it is executing, or for another language selected by a user, a language pack is downloaded to present all text for menus, help files, etc. into the desired language.

While firewalls are not generally associated with reduced network resources, they can pose a connectivity issue. The desktop sharing application uses HTTP tunneling via port 80 to bypass firewall security as port 80 is typically left open to allow Web browsing.

The conferencing server also supports differing port configurations, IPv6 and IP binding to provide a flexible and robust platform for conferencing.

The desktop sharing application provides multiple monitor support, wherein a participant can choose which monitor to share if there is more than one available.

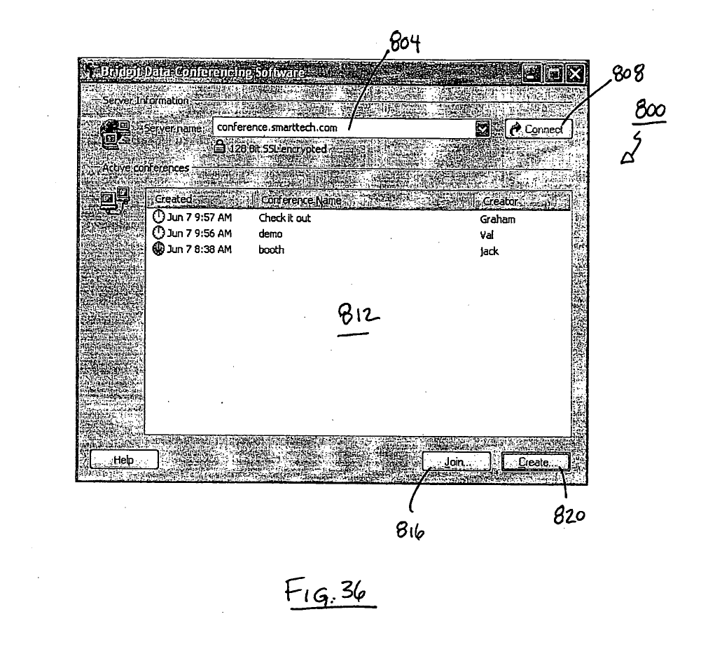

The desktop sharing application permits users to create and launch a conference. FIG. 36 shows a conference list dialog box 800 presented to a user who has previously downloaded the desktop sharing application and launches it directly from his computer. The dialog box indicates the server name field 804, a connect button 408, an active conference list 812, a join button 816 and a create button 820. The server name field 804 identifies the conferencing server 48 to which the desktop sharing application is connected. When the desktop sharing application is opened directly on a computer, the server name field indicates the last conferencing server to which the desktop sharing application was connected, along with any previous conferencing servers to which the desktop sharing application was connected in a drop-down list. The server name field 804 also permits editing to allow users to enter the names of servers to which they want to connect, but have not done so in the past. The connect button 808 causes the desktop sharing application to connect to a server whose name is entered into the server name field 804. The active conference list 812 indicates a list of the active conferences on the selected conferencing server. When a conference is selected from the active conference list 812 and the join button 816 is clicked on, the conferencing software attempts to connect to the selected conference. Alternatively, by clicking on the create button, a new conference can be created on the conferencing server.

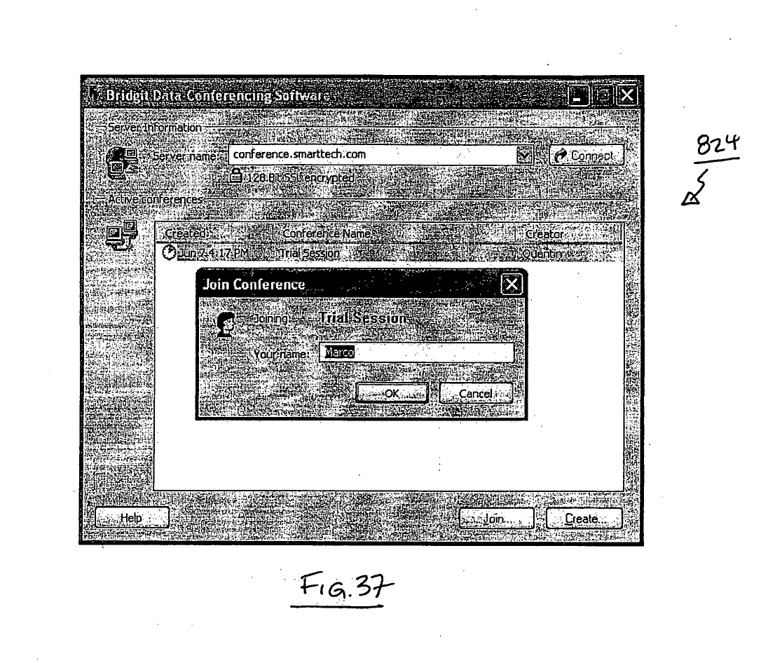

FIG. 37 shows a dialog box 824 that is presented upon clicking on the join button 816. The dialog box 824 permits a user to enter in their name that is to be displayed for purposes of the conference. If the conference being joined is password-protected, the dialog box 500 also provides a field in which to enter the password.

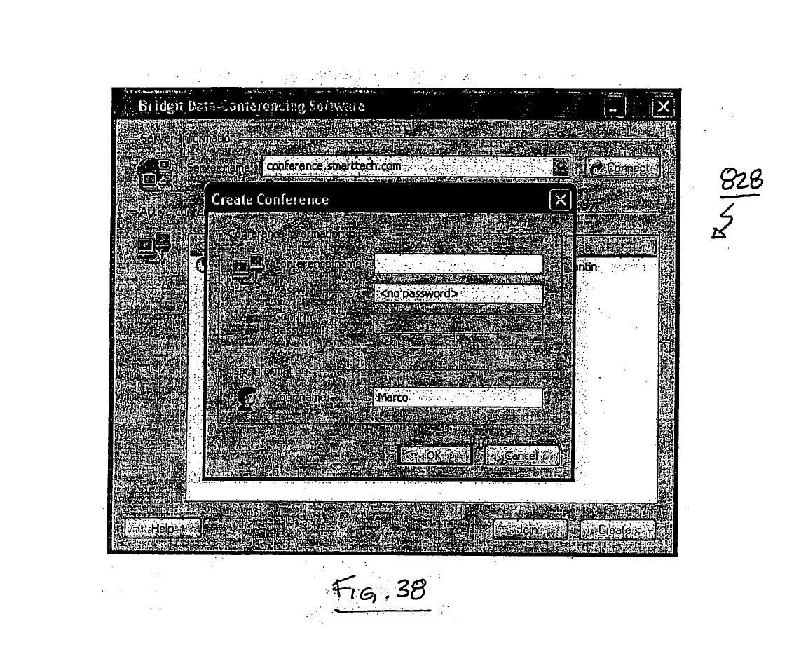

FIG. 38 shows a dialog box 828 that is presented upon clicking on the create button 820. The dialog box 828 permits a user to select a name for the conference that will then be shown in the active conference list 812. The dialog box also permits the user to set a password for the conference and enter in a name that will be displayed for purposes of the conference.

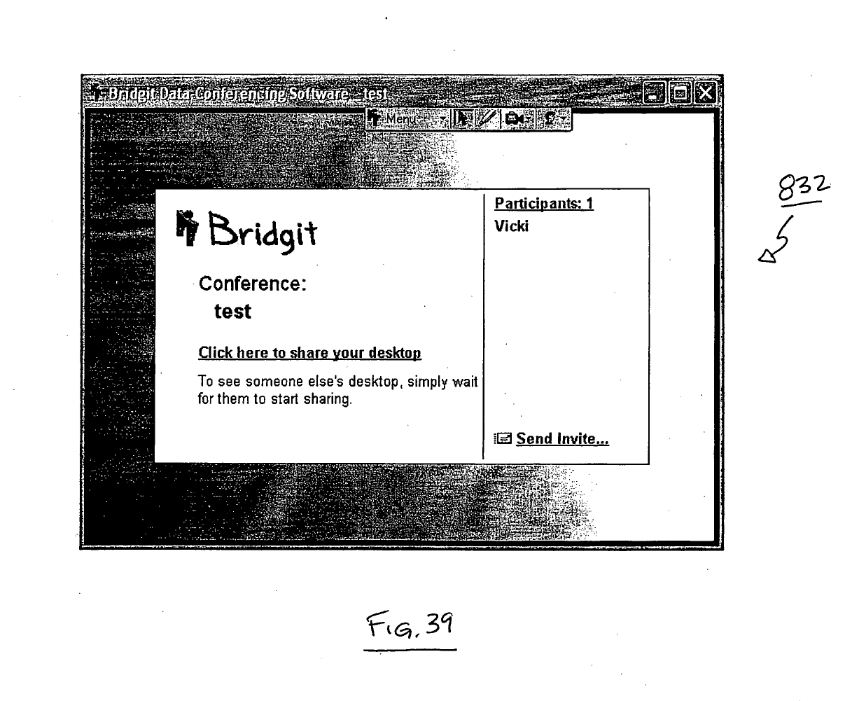

FIG. 39 shows a lobby window 832 of the desktop sharing application after having joined or created a conference. The lobby window 832 indicates the participants currently waiting to enter into a conference. A link to launch the conference is shown to the left. At bottom-right, a link is provided to allow an invitation to be sent to another user via email.

The exit option revealed by selecting the main menu button is selected when the conference is to be terminated. In this event, the host computer's desktop sharing application ceases transmission and reception of data. All viewers in the conference are then disconnected from the exiting presenter's desktop.

The desktop sharing application is designed to be temporarily or permanently installed on a computer. After having downloaded the desktop sharing application, executing it and terminating the application, the user is presented with a dialog box requesting if the user wishes to retain access to the program permanently (i.e. “install” it). If the user selects to “install” the desktop sharing application, a shortcut is created for it and placed on the user's desktop, otherwise the program simply terminates.

In addition, the desktop sharing application is also designed to ensure that it is using a version that is compatible with the conferencing server to which it is connecting. When the desktop sharing application connects to a conferencing server, it checks to see what version the server is expecting. If the desktop sharing application is a different version than desired, the application proceeds to download the correct version. While the server typically expects the same or a later version of the desktop sharing application, in some cases, the server can expect an earlier version. Regardless of whether the version to be downloaded is earlier or later than that presently executing, the desktop sharing application downloads the expected version of the application and saves it with a temporary name in the same directory. The original application then executes the downloaded application, and proceeds to terminate itself. The temporary-named application waits until the original application has terminated and then proceeds to copy itself over the original application. Once copied, the temporary-named application then launches the properly-named latest copy of the application with the appropriate parameters to connect to the conference, thereafter terminating itself. Once the properly-named latest copy of the application has launched, it waits for the temporary-named application to terminate and then deletes it. In this manner, the desktop sharing application updates itself to the expected or correct version, regardless of whether later or earlier.

While the selection of tile size has been described with some degree of specificity, a person skilled in the art would appreciate that other sizes of tiles can be selected without significantly affecting the working of the invention. For example, the tile size can be of a number of other dimensions that would be understood by those skilled in the art to not affect the efficiency of the method significantly. It would be appreciated that, by selecting a tile size that is very small, the benefit of compression is reduced. Further, by selecting a tile size that is very large, even a one pixel change within the tile would require that updated image data be sent for the entire tile.

The default tile size can be allowed to float to permit compensation for a number of factors. For example, if the presenter resizes the shared region, an end tile that is narrow can result from the fixed tile size, thereby reducing the efficiency of compression. It may be desirable, in such circumstances, to resize the tiles in order to ensure that no tile is less than a desired size. This can be achieved by reducing the default tile size in order to increase the size of the narrow end tile or by increasing the default size in order to make the narrow end tile disappear.

Alternatively, the default tile size can be set to be a generally fixed portion of the screen. For example, a shared region of 100 by 600 pixels can be divided into 100 evenly-sized tiles of 80 by 60 pixels. If the shared region is scaled, the tile size can be scaled correspondingly.

Additionally, the tile size can be adjusted tile by tile. For example, where a window in a shared region is frequently changing whereas the remainder of the shared region is generally static, those tiles that span both the window and the remainder of the shared region can be forced to update despite that only a portion of their content has changed. It can be desirable in such cases to adjust the tile sizes to force a set of tiles to cover the size of the window such that only those tiles need be regularly updated.

In some circumstances, it can be desirable to modify the threshold at which a delta is sent as a set of jpeg images. For example, the threshold can be dynamically modified to maintain a desired ratio of tiles in a delta that are compressed using Camtasia compression.

Those of skill in the art will appreciate that other types of image compression can be used, such as gif, png, tiff, etc. Different levels of the same compression type can be used, such as different levels of jpeg compression. Further, three or more types of compression can be used to compress the tiles using two thresholds or any other scheme that would occur to a person skilled in the art.

The loader application can be stored on a separate server from the conferencing server.

The conferencing server can be a cluster of servers located in a single, physical location or can be distributed across a network.

The above-described embodiments of the invention are intended to be examples of the present invention and alterations and modifications may be effected thereto, by those of skill in the art, without departing from the scope of the invention which is defined solely by the claims appended hereto.

What is claimed is:

1. In a distributed computer network where displayed information is shared between at least two computers, a method of displaying shared images comprising the steps of:
identifying image data within a selected display region of one computer that is to be shared with at least one other computer; and
displaying the identified image data at said at least one other computer.

2. The method of claim 1 wherein said selected display region is adjustable.

3. The method of claim 1 wherein said selected display region is dynamically adjustable.

4. The method of claim 3 wherein said selected display region is dynamically adjusted by moving a border within window frame, the area encompassed by said border constituting said selected display region.

5. The method of claim 1 wherein said selected display region is sized to exclude one or more controls displayed by said one computer.

6. The method of claim 1, further comprising:
displaying in a toolbar in the selected display region of said one computer, said toolbar being displayed at said at least one other computer.

7. The method of claim 6, wherein movement of the toolbar in the selected display region of said one computer results in movement of said toolbar being displayed at said at least one other computer.

8. In a distributed computer network where displayed information is shared between at least two computers, a method of displaying shared images comprising the steps of:
dividing image data of one computer that is to be shared with at least one other computer into a plurality of tiles;
examining the image data in the tiles to determine the nature thereof;
compressing the image data in the tiles using a compression methodology selected based on the determined nature; and
transmitting the compressed image data to said at least one other computer for display.

9. The method of claim 8 wherein during said compressing, at least two compression methodologies are available to compress the image data.

10. The method of claim 9 wherein one of said at least two compression methodologies is lossless and another of said at least two compression methodologies is lossy.

11. In a distributed computer network where displayed information is shared between at least two computers, a method of displaying shared images comprising the steps of:
identifying image data of one computer that is to be shared with at least one other computer during a presentation;
transmitting the identified image data to said at least one other computer for display; and
providing feedback at at least one of said one and other computers concerning the position of the at least one other computer within the presentation.

12. The method of claim 11 wherein the feedback is visual and is provided at both of said one and other computers.

13. The method of claim 12 wherein the feedback identifies when the at least one other computer falls behind in the presentation.

14. The method of claim 13 further comprising:
forcing the at least one other computer is selectively forced to catch up in the presentation.

15. The method of claim 14 wherein the at least one other computer is forced to catch up in the presentation if the at least one other computer falls behind by a pre-determined period of time in the presentation.

16. In a distributed computer network where displayed information is shared between at least two computers, a method of displaying shared images comprising the steps of:
identifying image data of one computer that is to be shared with at least one other computer during a presentation;
transmitting the identified image data to said at least one other computer for display;
detecting other computers that fall behind in the presentation; and
forcing other computers that fell behind in the presentation to catch up.

17. In a distributed computer network, a method of inviting a user to participate in an interactive session, comprising:
sending a message with a URL to the user, said URL identifying the address of a conferencing application enabling participation in the interactive session;
receiving a request from the user for the conferencing application;
associating the request with the session; and
transmitting the conferencing application and data identifying the session to the user.

18. A method of providing version control in an application, comprising:
executing an original version of the application, the original version residing in a permanent location;
retrieving a desired version of an application and storing the desired version in a temporary location;
executing the desired version in the temporary location;
terminating the execution of the original version of the application;
copying the desired version over the original version at the permanent location with the executing desired version;
executing the desired version at the permanent location; and
terminating execution of the desired version at the temporary location.

19. The method of claim 18, further comprising:
removing the desired version of the application at the temporary location.

20. A method of installing components dynamically on a computer, comprising:
determining with an application that a component containing functionality required by the application is not available on the computer;
retrieving the component containing the required functionality with the application; and
accessing the required functionality with the application.

21. In a conferencing system operating over a distributed computer network, a method of transmitting streaming video to a client from a plurality of streaming video sources, the client presenting a plurality of frames, each of the plurality of frames displaying streaming video from a separate streaming video source, the method comprising:
determining if a frame associated with streaming video has been hidden; and
terminating the transmission of streaming video associated with said hidden frame.

22. In a conferencing system operating over a distributed computer network, a method of transmitting streaming video to a client from a plurality of streaming video sources, the client presenting a plurality of frames, each of the plurality of frames displaying streaming video from a separate streaming video source, the method comprising:
transmitting streaming video to the client from each separate streaming video source at a frame rate at least partially dependent on the size of the frame in which each separate streaming video source is displayed.

23. In a conferencing application, a method of displaying streaming video from a plurality of streaming video sources, the method comprising:
presenting each of said plurality of streaming video sources in a plurality of frames, one of said frames being larger than the other of said frames;
detecting when a smaller frame has been selected; and
switching the position and size of said one frame and said selected smaller frame.

24. In a distributed computer network where displayed information is shared between at least two computers, a method of displaying shared images comprising the steps of:
enabling a first participant to generate annotations on a shared region of a desktop of one computer; and
displaying the annotations on the shared region of the desktop on a second computer.

25. The method of displaying shared images of claim 24, further comprising:
enabling a second participant to generate annotations on the shared region of the desktop via the second computer; and
displaying the annotations on the shared region of the desktop on the first computer.

26. The method of displaying shared images of claim 25, wherein said annotations generated on the first computer are distinguishable from the annotations generated on the second computer.

27. The method of displaying shared images of claim 26, wherein said annotations generated on the first computer are displayed in a first color and the annotations generated on the second computer are displayed in a second color that is distinguishable from the first color.

28. In a distributed computer network where displayed information is shared between at least two computers, a method of displaying a shared desktop comprising the steps of:
sharing a region of a first computer's desktop with a second computer; and
modifying the display of said region at said second computer to identify displayed controls unavailable to the second computer.

29. In a distributed computer network where displayed information is shared between at least two computers, a method of displaying a shared desktop comprising the steps of:
sharing a region of a first computer's desktop with a second computer; and
modifying the display of said region at said second computer to identify displayed applications unavailable to the second computer.

30. The method of displaying a shared desktop of claim 29, further comprising:
presenting a list of applications on the first computer to permit the user to select which of said applications are to be hidden.

31. A desktop sharing application, comprising:
a shared display region;
said desktop sharing application being dynamically conditionable between a host mode, wherein said shared display region displays a shared region of the desktop of a computer upon which the desktop sharing application is executing, and a client mode, wherein said shared display region displays a shared region of the desktop of another computer executing the desktop sharing application conditioned in host mode with which said desktop sharing application is in communication.

32. In a distributed computer network where displayed information is shared between at least two computers, a method of displaying a shared desktop comprising the steps of:
sharing a region of a desktop on a first computer with a second computer;
receiving by the first computer a request from the second computer to share a region of the second computer's desktop; and
sharing the region of the second computer's desktop with the first computer.
